(19) United States
(12) Patent Application Publication
(10) Pub. No.: US 2020/0037267 A1
(43) Pub. Date: Jan. 30, 2020

(54) SYSTEM, METHOD AND APPARATUS FOR REDUCING EXPOSURE TO ELECTROMAGNETIC RADIATION

(71) Applicant: Stephanie Gray, Hiawatha, IA (US)

(72) Inventor: Stephanie Gray, Hiawatha, IA (US)

(21) Appl. No.: 16/521,314

(22) Filed: Jul. 24, 2019

Related U.S. Application Data
(60) Provisional application No. 62/702,501, filed on Jul. 24, 2018.
(60) Provisional application No. 62/702,533, filed on Jul. 24, 2018.
(60) Provisional application No. 62/702,545, filed on Jul. 24, 2018.
(60) Provisional application No. 62/702,558, filed on Jul. 24, 2018.

(51) Int. Cl. H04W 52/28; H04W 52/02; H04W 36/08; H04W 48/20; H01Q 1/24; H04W 72/04

(52) U.S. Cl. CPC H04W 52/283; H04W 52/0251; H04W 36/08; H04W 72/0453; H01Q 1/245; H04W 72/0473; H04W 48/20

(57) ABSTRACT

A system and method for mitigating man-made electromagnetic radiation including a wireless broadcasting antenna for emitting radio waves that communicates with a personal device having antennae, said antennae including a wireless receiving antenna for receiving the radio waves that is used in a safer space designed to substantially minimize harmful electromagnetic radiation, where the safer space can be created through the use of several options, including material to absorb harmful electromagnetic radiation, systems to reduce antennae broadcast power and/or select a preferred wireless access point that minimizes the distance between antennae of the personal device and a wireless access point while preferably simultaneously reducing the power or output to other wireless access points in the safer space or intelligently turning off broadcast power or wireless communications of the personal device, intelligently turning off a non-selected wireless access point; and/or shifting a frequency of wireless transmissions to employ less harmful frequencies.

### CROSS REFERENCE TO RELATED APPLICATIONS

This application claims priority and is related to U.S. Provisional Application Ser. No. 62/702,501 filed on Jul. 24, 2018 and entitled System, Method and Apparatus For Reducing Exposure To Electromagnetic Radiation, U.S. Provisional Application Ser. No. 62/702,533 filed on Jul. 24, 2018 and entitled System, Method and Apparatus For Reducing Exposure To Electromagnetic Radiation, U.S. Provisional Application Ser. No. 62/702,545 filed on Jul. 24, 2018 and entitled System, Method and Apparatus For Reducing Exposure To Electromagnetic Radiation, and U.S. Provisional Application Ser. No. 62/702,558 filed on Jul. 24, 2018 and entitled System, Method and Apparatus For Reducing Exposure To Electromagnetic Radiation. The entire contents of this patent application are hereby expressly incorporated herein by reference including, without limitation, the specification, claims, and abstract, as well as any figures, tables, or drawings thereof.

### FIELD OF THE INVENTION

The present invention relates to a system, method and apparatus for reducing the human body to exposure to electromagnetic radiation.

### BACKGROUND OF THE INVENTION

The term “radiation” describes the diffusion of energy within a space either in the form of particles, such as electrons, or in the form of waves, such as radio waves.

Radiation is part of our lives. We are surrounded by a vast amount of natural and artificial sources of radiation. Human senses can detect only a small portion of the electromagnetic spectrum. We can detect visible light though our eyes, and ultraviolet radiation through heat.

But, the electromagnetic spectrum is far greater than what a human being can detect.

Natural radiation sources include natural radioisotopes found in the soil, subsoil, air, and water. The sun is also a natural source of radiation, and so is the cosmic radiation emitted by celestial bodies.

Artificial sources of radiation include devices which generate radiation, such as equipment used in medical applications, lamps, radars, antennas, etc.

Radiation is characterized by its wave length or its frequency and the energy it carries. Depending on its wavelength, energy, and impact on matter, radiation is classified into two major categories: 1) ionizing radiation, and 2) non-ionizing radiation.

Ionizing radiation has sufficient energy to be able to cause ionization. To understand ionization energy, we must first understand what an ion” is. An ion is created when a neutral atom gives or receives an extra electron. When an atom gains or loses electrons, it changes its charge.

Therefore, ionization is any process that changes the electrical balance within an atom. If an electron is removed from a stable atom, the atom becomes electrically incomplete. In other words, there are more protons in the nucleus (positive charges) than there are electrons (negative charges). X rays, gamma rays, electrons, protons and neutrons are forms of ionizing radiation.

Non-ionizing radiation carries far lower energy, and cannot cause ionization of matter. However, the energy carried by non-ionizing radiation is capable of causing electric, chemical and thermal impact on matter. Non-ionizing radiation covers the spectrum from low-frequency electric and magnetic fields to ultraviolet radiation.

The impact of radiation on human life is complicated, sometimes favorable and sometimes adverse, depending on the type of radiation, and the volume and the energy being carried.

Naturally occurring radiation is everywhere in the universe, it is unavoidable fact of life. We are constantly immersed in a sea of Alpha particles, beta particles, gamma rays, muons, neutrinos, etc. Most of this radiation has nothing to do with human activities

Also, the Earth is naturally radioactive. We can find some radioactive substances like uranium and thorium in rocks such as granite, sandstone and limestone.

As rocks weather, they form soils which also contain traces of radioactive materials. The resulting soils are washed into streams and rivers. So humans are constantly exposed to background radiation directly from rocks, soils, streams and trees.

Our air contains two radioactive gases, radon and thoron. These gases come from uranium and thorium in Earth's crust.

As these gases seep into the air, they disperse with a low concentration. But when they enter a building through floor and building materials, the concentration can increase unless the building is well ventilated.

The amount of naturally occurring background radiation that a person receives depends on: 1) the altitude above sea level where you live, 2) the materials used in the construction of your building, 3) the way a building is constructed and ventilated and the composition of underlying rocks.

According to one study, the average American gets a dose of around 360 millirems of radiation per year—roughly the equivalent of 36 X-rays.

About 200 millirems of that comes from radon gas, a colorless, odorless by-product of natural uranium, found in trace amounts almost everywhere. The radioactive decay of radon gas produces alpha particles (consisting of two protons and two neutrons, an alpha particle is just the bare nucleus of a helium atom), beta particles (which are actually fast-moving electrons), and gamma rays (very energetic photons). Radon is not a problem for most people, but in some locations it can accumulate in houses to dangerous levels.

Medical X-rays come in second place, dosing a person with 53 millirems a year on average.

The next biggest external source of radiation is everything else that is around us, contributing about 28 millirems per year. This includes the food we eat, the clothes we wear, even the paper of this magazine—all are naturally laced with tiny amounts of unstable isotopes, radioactive cousins of normal atoms.

As an example, all living things require potassium, and one out of every 8,550 potassium atoms is radioactive potassium-40, meaning that all food emits a little bit of radiation. Since bananas are high in potassium, they are actually one of the most radioactive foods. Eating 600 bananas is about the equivalent of having one chest X-ray.

Radiation from cosmic rays comes in next, at 27 millirems per year. Cosmic rays are mostly protons plus a smattering of alpha particles and other atomic nuclei. Their origin is not understood, but they come from every direction in space, traveling at almost the speed of light. Cosmic rays smash into the upper atmosphere, producing a secondary cascade of exotic particles like muons, short-lived heavyweight versions of electrons. Each muon has the same charge as an electron but over 200 times the mass. As these particles penetrate deeper and deeper into the atmosphere, more and more of it gets absorbed. This means that living in Denver will expose a human to more radiation than living in a sea-level city like New Orleans. For every hundred feet of altitude, the annual dose from radiation increases by 1 millirem per year. A six-hour airplane trip will immediately add 2 millirems or so to a human's annual exposure.

Consumer products like smoke detectors—which rely on a small alpha-particle-emitting lump of americium-241—add 10 millirems per year.

Contamination from atomic weapons tests contribute less than 1 millirem. Nuclear power plants supply the same small dose, on average.

Finally, there are neutrinos. These are emitted by the quadrillion from the fusion factory at the core of the sun and easily pass through most matter. Occasionally, a neutrino will collide with an atom, adding to a human's radiation dose. But, a person would have to be alive for a million years to get the same dose from solar neutrinos as they'd get from eating a single banana.

All of the above are external sources of radiation, but 40 millirems of our annual dose is internal, generated from the decay of isotopes incorporated into the molecules of our being: a potassium-40 atom in the brain firing off a gamma ray here, a carbon-14 atom in the liver spitting out a beta particle there. Enough radiation escapes our bodies that sleeping nightly with another person adds 1 millirem to your annual dose.

No one can avoid natural background radiation. Humans have lived with it in the environment since beginning of time. Background radiation in our everyday environment does not cause widespread harm.

In some places in Iran, India and Europe, where natural background radiation gives a higher annual and lifetime dose of background radiation, there is no evidence of increased cancers or other health problems arising from these high natural levels.

The science of biophysics has established that all life on the planet is finely tuned with our environment. All our various human biorhythms, organs and metabolic functions are designed to run synchronously with the various frequencies of the earth and universe.

As an example, one of the beneficial pulse rhythms are Schumann waves, which are found in the ionosphere with a frequency of 7.83 Hz. This corresponds precisely with the frequency of hippocampus in the brain of all mammals. The hippocampus in human is responsible for our memory and survival, among other things.

Our nervous system also responds to electromagnetic pulses of Schumann waves.

Human's are an energy system that depends on balanced and natural energies around us for our health, well-being and survival.

Even NASA (National Aeronautics and Space Administration) has built Schumann Wave Generators into its manned space flights to keep astronauts physiologically and psychologically healthy.

However, Schumann waves can be altered by interference frequencies from all forms of radio communication transmitters, and high-tension power lines.

So, there is ample evidence that human beings have been designed to live in harmony with naturally occurring background radiation.

There is also ample evidence that man-made sources of electromagnetic radiation can interfere in a detrimental manner with naturally occurring background radiation that in many instances is necessary for life.

Humans live normally in the presence of natural background radiation. Disruption of these natural radiations with man-made electromagnetic devices cause imbalances in human's bodies, which has effects on our health.

In the 20 and 21 centuries, the world was introduced to man-made sources of electromagnetic radiation. In our day, these man-made sources of non-ionizing, electromagnetic radiation are proliferating daily. These sources include, but are not limited to, power lines, cell phones,

SmartTVs, WiFi access points, cell phone towers, computers, microwave ovens, electrical appliances, and X-rays, medical devices, etc.

Electromagnetic radiation is an invisible health hazard spreading out of control worldwide.

Electromagnetic radiation can cause leukemia in children and breast cancer in adults. It is linked to health and medical problems such as damaged cells and DNA, heart problems, nervous disorders, birth defects, miscarriages, cataracts, Alzheimer's disease, stress, chronic fatigue, headache and nausea.

Every second, every minute, every hour and every day, humans are being bathed in a dangerous pollution of man-made, non-ionizing electronic smog. This threat is something we can't see, hear, smell, feel, or taste. But, it is in our homes, workplaces and schools. It constantly surrounds us.

Man-made electromagnetic radiation (EMR) is the dark side of technology. Man-made microwave and related radiation is estimated to be up to 1 billion times greater as that which naturally exists in the environment today.

In this century, cell phones that connect us via voice and data to other persons and information stored on the Internet have become ubiquitous. There are now more cell phones (over 7.2 billion devices) than there are people on the planet. It is estimated that in 2018 there will be one WiFi access point for every twenty people on the planet.

What is needed is a system, method, and apparatus for creating safer spaces where the power of man-made electromagnetic radiation is reduced significantly for the benefit of human beings who are in close proximity to the source of the man-made electromagnetic radiation.

### OBJECTS AND FEATURES

It is an object of the present invention to create safer spaces.

It is an object of the present invention to create safer spaces by mitigating harmful electromagnetic radiation.

It is an object of the present invention to create safer spaces by mitigating harmful man-made electromagnetic radiation.

It is an object of the present invention to create safer spaces by mitigating man-made electromagnetic radiation by absorbing harmful radiation.

It is an object of the present invention to create safer spaces by mitigating man-made electromagnetic radiation by reducing antennae broadcast power.

It is an object of the present invention to create safer spaces by mitigating man-made electromagnetic radiation by decreasing the distance between the antennae of personal devices and wireless access points.

It is an object of the present invention to create safer spaces by mitigating man-made electromagnetic radiation by increasing the distance between the antennae of a personal device operating on a low-power wireless standard and a remote cellular broadcast antenna.

It is an object of the present invention to create safer spaces by mitigating man-made electromagnetic radiation by intelligently turning off a personal device's broadcast power.

It is an object of the present invention to create safer spaces by mitigating man-made electromagnetic radiation by intelligently turning off a wireless access point when it is not needed.

It is an object of the present invention to create safer spaces by mitigating man-made electromagnetic radiation by intelligently turning off wireless communications on a personal device when it is not needed.

It is an object of the present invention to create safer spaces by mitigating electromagnetic radiation by increasing the number of wireless access points in a space to reduce required broadcast power.

It is an object of the present invention to actively vary the broadcast power of WiFi devices.

It is an object of the present invention to create safer spaces by frequency shifting wireless transmissions to a less harmful frequency.

It is an object of the present invention to create safer spaces by frequency shifting wireless transmissions to a frequency that is beneficial to human life.

It is an object of the present invention to integrate a wireless access point with a controller area network engine and a cellular network antenna booster into a single device.

It is an object of the present invention to integrate a controller area network engine and a cellular network antenna booster into a single device, which can connect to at least one wireless access point.

It is an object of the present invention to connect to wireless access points via integrated wired routers.

It is an object of the present invention to use a software application operating on a smartphone, or tablet, to coordinate the communication with an “integrated wireless access point—controller area network engine—cellular network antenna booster device”, in order to mitigate electromagnetic radiation.

It is an object of the present invention to use software on a personal computer to coordinate communication with an “integrated wireless access point—controller area network engine—cellular network antenna booster device”, in order to mitigate electromagnetic radiation.

It is an object of the present invention to use software on a set-top box to coordinate communication with an “integrated wireless access point—controller area network engine—cellular network antenna booster device”, in order to mitigate electromagnetic radiation.

It is an object of the present invention to use software on a Smart TV to coordinate communication with an “integrated wireless access point—controller area network engine—cellular network antenna booster device”, in order to mitigate electromagnetic radiation.

It is an object of the present invention to use software on a wireless networked printer to coordinate communication with an “integrated wireless access point—controller area network engine—cellular network antenna booster device”, in order to mitigate electromagnetic radiation.

It is an object of the present invention to use software on a streaming device that plugs into an HDMI port to coordinate communication with an “integrated wireless access point—controller area network engine—cellular network antenna booster device”, in order to mitigate electromagnetic radiation,

It is an object of the present invention to use software on an e-reader to coordinate communication with an “integrated wireless access point—controller area network engine—cellular network antenna booster device”, in order to mitigate electromagnetic radiation.

It is an object of the present invention to use software on a gaming console to coordinate communication with an “integrated wireless access point—controller area network engine—cellular network antenna booster device”, in order to mitigate electromagnetic radiation.

It is an object of the present invention to use software on a voice activated assistant device to coordinate communication with an “integrated wireless access point—controller area network engine—cellular network antenna booster device”, in order to mitigate electromagnetic radiation.

It is an object of the present invention to use software on an Internet of Things device that uses Z-Wave to coordinate communication with an “integrated wireless access point—controller area network engine—cellular network antenna booster device”, in order to mitigate electromagnetic radiation.

It is an object of the present invention to use software on an Internet of Things device that uses ZigBee to coordinate communication with an “integrated wireless access point—controller area network engine—cellular network antenna booster device” in order to mitigate electromagnetic radiation.

It is an object of the present invention to use software on an Internet of Things device that uses Bluetooth to coordinate communication with an “integrated wireless access point—controller area network engine—cellular network antenna booster device” in order to mitigate electromagnetic radiation.

It is an object of the present invention to use the Cloud to house an enterprise back end that is required to deploy the “safer space” web apps.

It is an object of the present invention to use the Cloud to house an enterprise back end that is required to deploy the “safer space” web services.

It is an object of the present invention to use the Cloud to house an enterprise back end that is required to deploy the “safer space” client identification and passwords.

It is an object of the present invention to use the Cloud to house an enterprise back end that is required to deploy the “safer space” rights and permissions.

It is an object of the present invention to use Docker software as part of the enterprise IT system.

It is an object of the present invention to use React software as part of the enterprise IT system.

It is an object of the present invention to use the enterprise IT system for use in social networking apps.

It is an object of the present invention to use the enterprise IT system for use in marketing products related to healthy living via an app.

It is an object of the present invention to use electromagnetic radiation mitigating kiosks.

It is an object of the present invention's kiosks to include an electromagnetic radiation mitigating enclosure for a smartphone or tablet computer.

It is an object of the present invention's kiosks to include a dock for a smartphone or tablet computer.

It is an object of the present invention's kiosks to include a touchscreen and mouse to interact with the docked smartphone or tablet computer.

It is a feature and object of the present invention to use Ethernet technology to provide functionality.

It is an object of the present invention to use low voltage wiring technology to provide functionality.

It is an object of the present invention to use twisted pair cable technology to provide functionality.

It is an object of the present invention to use Category 5 cable technology to provide functionality.

It is an object of the present invention to use Category 6 cable technology to provide functionality.

It is an object of the present invention to use router technology to provide functionality.

It is an object of the present invention to use Power-over-Ethernet technology to provide functionality.

It is an object of the present invention to use powerline communication technology to provide functionality.

It is an object of the present invention to use network switch technology to provide functionality.

It is an object of the present invention to use ultra-wideband technology to provide functionality.

It is an object of the present invention to enclose sources of electromagnetic radiation in Faraday Cages.

It is an object of the present invention to reduce electromagnetic radiation in automobiles.

It is an object of the present invention to reduce electromagnetic radiation in airplanes.

It is an object of the present invention to reduce electromagnetic radiation in buses.

It is an object of the present invention to reduce electromagnetic radiation in trucks.

It is an object of the present invention to reduce electromagnetic radiation in trains.

It is an object of the present invention to provide a marketing system.

An object of the marketing system of the present invention includes the use of mobile apps.

An object of the marketing system of the present invention includes the use of text messages.

An object of the marketing system of the present invention includes the use of email.

An object of the marketing system of the present invention includes the use of kiosks.

An object of the marketing system of the present invention includes the provision on an on-line store.

An object of the present engine to provide a social media engine.

It is an object of the present invention to solve the problems illustrated in the prior art.

### SUMMARY OF INVENTION

The present invention is a system, method, and apparatus for mitigating man-made electromagnetic radiation (EMR) to create safer spaces.

The present invention employs a variety of methods to create EMR safer Spaces. These methods include, but are not limited to: 1) decreasing the distance between a wireless broadcast antenna and a wireless receiving antenna; 2) increasing the distance between the antennae of a personal device operating on a low-power wireless standard and a remote cellular broadcast antenna; 3) increasing the number of wireless access points operating in a space in order to reduce the amount of energy that is required to transmit and receive; 4) automatically switching off a cellular radio in a safer space and automatically switching to WiFi; using a gateway that is configured to transmit and receive WiFi signals only within a safer space, 5) this gateway includes an integrated controller area network device which manages WiFi calling and the routing of data via the ISP's modem and the cellular network, and also includes a cellular signal booster that operates outside the safer space in order to remove cellular transmission as far from the safer space as is practical; 6) the use of wired Ethernet connections to the gateway device so all wireless radios on a smartphone or tablet computer or laptop computer can be turned off, the Ethernet connections can be routed over CAT 5/6/7 cabling on via power-line communications (PLC) via an RJ45 Jack to a PLC Jack; 7) EMR anti-radiation fabrics and anti-radiation paints (coatings) on walls and ceilings that absorb multi-path signals; mini-safer space rooms within a larger room that are designed to shield a human being from much of the uncontrolled EMR while in the mini-safer space room; 8) shifting wireless transmit and receive signals to another frequency that is less harmful to human beings; 9) shifting wireless transmit and receive signals to frequencies that are beneficial to human beings, 10) broadcasting frequencies that are beneficial to human beings, and 11) actively varying the transmit power of WiFi. In the present invention, these methods can be employed individually, or in combination.

The present invention includes an enterprise back-end information technology system that operates in the public Cloud, a private Cloud, a hybrid public Cloud, or a hybrid public-private Cloud.

The present invention also includes apps that can be downloaded to smartphones and tablet computers that interact with the present invention's gateway device, which is an “integrated wireless access point—controller area network engine—cellular network antenna booster device”, which helps mitigate EMR within a safer space.

The present invention also includes software that can be downloaded to laptop computers, and desktop PCs that interact with the present invention's gateway device, which is an “integrated wireless access point—controller area network engine—cellular network antenna booster device”, which helps mitigate EMR within a safer space.

These features of the present invention will be described in more detail in the detailed description of the various embodiments of the present invention.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is an illustration of the present art.

FIG. 2 is an illustration of the network topology of the present invention.

FIG. 3 is a block diagram of the present invention's gateway device.

### DESCRIPTION OF EMBODIMENTS

The present invention relates to a system, method, and apparatus for mitigating electromagnetic radiation (EMR) that is potentially harmful to human beings, particularly, man-made sources of EMR. The goal of the present invention is to create EMR safer Spaces.

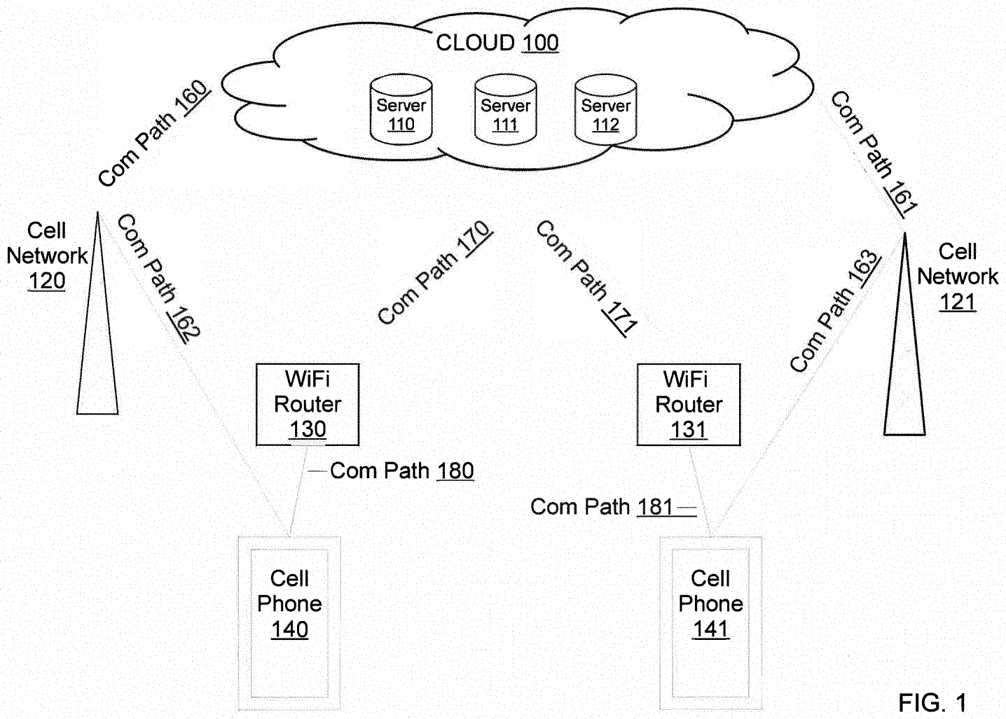

FIG. 1 is an illustration of the present art, which includes the following elements and objects.

Cloud 100, aka the Internet, is a global system of interconnected computer networks that use the Internet protocol suite (TCP/IP) to link several billion devices worldwide. It is a network of networks that consists of millions of private, public, academic, business, and government networks of local to global scope, linked by a broad array of electronic, wireless, and optical networking technologies. The Internet carries an extensive range of information resources and services, such as the inter-linked hypertext documents and applications of the World Wide Web (WWW), the infrastructure to support email, telephony, and peer-to-peer networks for file sharing.

Cloud 100 may be configured as a hybrid cloud. A hybrid cloud is a composite cloud service that crosses the boundaries of private, public, and community clouds that extends the capacity and capability, via aggregation and integration, of the composite cloud service provided by the present invention. As an example, the present invention may store sensitive client data in house on a private cloud application and interconnect that application to a business intelligence application provided on a public cloud, as a software service. Monitoring framework integration, a Run-time Performance Manager and pervasive operational controls with tools like Integration Bus Remote Control, Task Scheduler, Operational Dashboard, and a Representational State Transfer (REST) API for Management.

Cloud 100 includes Server 110, 111, 112. Server 110, 111, 112 are compute devices that run computer programs that provide functionality for other programs or devices, which are usually called “clients”. This architecture is called the client-server model, and a single overall computation is distributed across multiple processes or devices. Server 110, 111, 112 provide various functionalities, often called “services”, such as sharing data or resources among multiple clients, or performing computation for a client. A single server 110, 111, 112 can serve multiple clients, and a single client can use multiple Servers 110, 111, 112. A client process may run on the same device or may connect over a network to a server on a different device. Typical servers that may be used within the present invention include, but are not limited to, database servers, file servers, mail servers, print servers, web servers, and application servers.

Client-server systems usually use the “request-response model”. A client device, such as, but not limited to, Cell Phone 140, 141 sends a request to a server 110, 111, 112, which performs some action and sends a response back to the client, typically with a result or acknowledgment.

The present art includes Cell Network 120, 121 infra-structure. A Cell Network 120, 121, also known as mobile network, is a communication network where the last communication link 162, 163 is wireless. The network is distributed over land areas called cells, each served by at least one fixed-location transceiver, but more normally three cell sites or base transceiver stations. These base stations provide the cell with the network coverage which can be used for transmission of voice, data and others. A cell typically uses a different set of frequencies from neighboring cells, to avoid interference and provide guaranteed service quality within each cell.

When joined together these cells provide radio coverage over a wide geographic area. This enables a large number of portable transceivers, such as, but not limited to, Cell Phones 140, 141, tablets (not shown), laptops (not shown), or any device equipped with a mobile broadband modem, to communicate with each other and with fixed transceivers and telephones anywhere in the network, via base stations, even if some of the transceivers are moving through more than one cell during transmission.

Cell Networks 120, 121 are both voice and data cellular networks. They are designed to allow mobile Cell Phones 140, 141 and mobile computing devices, such as, but not limited to, tablets (not shown), laptops (not shown), or any device equipped with a mobile broadband modem to be connected to the public switched telephone network (PSTN) and the public Internet. In addition, Cell Networks 120, 121 may be configured as private cell networks.

The present art is also for telecommunicating voice and data also includes WiFi Routers 130, 131. WiFi or Wi-Fi is a technology for wireless local area networking with devices based on the IEEE 802.11 standards. WiFi is a trademark of the WiFi Alliance, which restricts the use of the term WiFi Certified to products that successfully complete inter-operability certification testing.

Devices that can use WiFi technology include, but is not limited to, personal computers (not shown), video-game consoles (not shown), Cell Phones 140, 141, tablets (not shown), digital cameras (not shown), smart TVs (not shown), digital audio players (not shown), printers (not shown), etc. WiFi compatible devices can connect to the Internet via a WLAN and a wireless access point, described as WiFi Routers 130, 131. In the present art, the term WiFi Routers 130, 131 includes WiFi Routers, WiFi Antennae, and other network routers and switches that may comprise a WiFi network.

WiFi Routers 130, 131 typically have a range of about 20 to 100 meters, depending on whether the WiFi Routers 130, 131 are located indoors, or outdoors.

WiFi coverage can be as small as a single room with walls that block radio waves, or as large as many square kilometers achieved by using multiple overlapping access points.

WiFi most commonly uses the 2.4 gigahertz (12 cm) UHF and 5.8 gigahertz (5 cm) SHFISM radio bands. Anyone within range with a wireless modem can attempt to access the network. WiFi is more vulnerable to attack (called eavesdropping) than wired networks. WiFi Protected Access is a family of technologies created to protect information moving across WiFi networks and includes solutions for personal and enterprise networks. Security features of WiFi Protected Access constantly evolve to include stronger protections and new security practices as the security landscape changes. To connect to a WiFi LAN, a computer has to be equipped with a wireless network interface controller. The combination of computer and interface controller is called a station. For all stations that share a single radio frequency communication channel, transmissions on this channel are received by all stations within range. The transmission is not guaranteed to be delivered and is therefore a best-effort delivery mechanism. A carrier wave is used to transmit the data. The data is organized in packets on an Ethernet link, referred to as “Ethernet frames”.

WiFi technology may be used to provide Internet access to devices that are within the range of a wireless network that is connected to the Internet. The coverage of one or more interconnected WiFi Routers 130, 131 can extend from an area as small as a few rooms to as large as many square kilometers. Coverage in the larger area may require a group of WiFi Routers 130, 131 access points with overlapping coverage.

WiFi technology provides service in private homes, businesses, as well as in public spaces as WiFi Routers 130, 131 are set up either free-of-charge or commercially, which often use captive portal webpages to gain access. Organizations and businesses, such as airports, hotels, and restaurants, often provide free-use hot spots to attract customers. Enthusiasts or authorities who wish to provide services or even to promote business in selected areas sometimes provide free WiFi access.

Routers that incorporate a digital subscriber line modem (DSL) or a cable modem and a WiFi Router 130, 131, set up in homes and other buildings, provide Internet access and Internet working to all devices connected to them, wireless or via cable.

There are also battery-powered routers which may include a cellular Internet radio modem and WiFi Router 130, 131. When subscribed to a cellular data carrier, these devices such as, but not limited to Cell Phones 140, 141, tablets (not shown), etc., allow nearby WiFi stations to access the Internet over 2G, 3G, or 4G networks using a tethering technique. Many Cell Phones 140, 141 now have a built-in capability of this sort, including, but not limited to, those based on Android, BlackBerry, Bada, iOS (iPhone), Windows Phone and Symbian, though carriers often disable the feature, or charge a separate fee to enable it, especially for customers with unlimited data plans. “Internet packs” provide standalone facilities of this type as well, without use of a smartphone; examples include the MiFi- and WiBro-branded devices. Some laptops (not shown) that have a cellular modem card can also act as mobile Internet WiFi Router 130, 131.

There are many campuses and entire cities around the world that provide pervasive WiFi Router 130, 131 networks.

WiFi also allows communications directly from one computer to another without an access point intermediary. This is called ad hoc WiFi transmission. This wireless ad hoc network mode has proven popular with multiplayer handheld game consoles, such as, but not limited to, the Nintendo DS (not shown), PlayStation Portable (not shown), digital cameras (not shown), and other consumer electronics devices. Some devices can also share their Internet connection using ad hoc, becoming hot spots or “virtual” WiFi Routers 130, 131.

The WiFi Alliance promotes the specification WiFi Direct for file transfers and media sharing through a new discovery and security methodology.

Another mode of direct communication over WiFi is Tunneled Direct Link Setup (TDLS), which enables two devices on the same WiFi network to communicate directly, instead of via the WiFi Router's 130, 131 access point.

In addition to running on different channels, multiple WiFi networks can share channels.

A WiFi signal occupies five channels in the 2.4 GHz band. Any two channel numbers that differ by five or more, such as 2 and 7, do not overlap. The oft-repeated adage that channels 1, 6, and 11 are the only non-overlapping channels is, therefore, not accurate. Channels 1, 6, and 11 are the only group of three non-overlapping channels in North America and the United Kingdom. In Europe and Japan using Channels 1, 5, 9, and 13 for 802.11g and 802.11n is recommended.

802.11a uses the 5 GHz U-NII band, which, for much of the world, offers at least 23 non-overlapping channels rather than the 2.4 GHz ISM frequency band, where adjacent channels overlap.

WiFi connections can be disrupted or the Internet speed lowered by having other devices in the same area. Many 2.4 GHz 802.11b and 802.11g access-points default to the same channel on initial startup, contributing to congestion on certain channels. WiFi pollution, or an excessive number of WiFi Routers 130, 131 in the area, especially on the neighboring channel, can prevent access and interfere with other devices' use of other access points, caused by overlapping channels in the 802.11g/b spectrum, as well as with decreased signal-to-noise ratio (SNR) between access points. This can become a problem in high-density areas, such as large apartment complexes or office buildings with many WiFi Routers 130, 131

Additionally, other devices (not shown) use the 2.4 GHz band: microwave ovens, ISM band devices, security cameras, ZigBee devices, Bluetooth devices, video senders, cordless phones, baby monitors, and, in some countries, amateur radio, all of which can cause significant additional interference. It is also an issue when municipalities or other large entities, such as, but not limited to a university campus, seek to provide large area coverage.

A service set is the set of all the devices associated with a particular WiFi network. The service set can be local, independent, extended or mesh. Each service set has an associated identifier, the 32-byte Service Set Identifier (SSID), which identifies the particular network. The SSID is configured within the devices that are considered part of the network, and it is transmitted in the packets. Receivers ignore wireless packets from networks with a different SSID.

As the 802.11 specifications evolved to support higher throughput, the bandwidth requirements also increased to support them. 802.11n uses double the radio spectrum/bandwidth (40 MHz) compared to 802.11a or 802.11g (20 MHz). This means there can be only one 802.11n network on the 2.4 GHz band at a given location, without interference to/from other WLAN traffic. 802.11n can also be set to limit itself to 20 MHz bandwidth to prevent interference in dense community.

Many consumer devices (not shown) support the latest 802.11ac standard, which uses the 5 GHz band exclusively and is capable of multi-station WLAN throughput of at least 1 gigabit per second, and a single station throughput of at least 500 Mbit/s. In the first quarter of 2016, The WiFi Alliance certifies devices compliant with the 802.11ac standard as “WiFi CERTIFIED ac”. This new standard uses several advanced signal processing techniques such as multi-user MIMO and 4×4 Spatial Multiplexing streams, and large channel bandwidth (160 MHz) to achieve the Gigabit throughput.

WiFi allows wireless deployment of local area networks (LANs). Also, spaces where cables cannot be run, such as outdoor areas and historical buildings, can host wireless LANs. However, building walls of certain materials, such as stone with high metal content, can block WiFi signals.

A wireless access point (WAP) connects a group of wireless devices to an adjacent wired LAN. An access point resembles a network hub, relaying data between connected wireless devices in addition to a (usually) single connected wired device, most often an Ethernet hub or switch, allowing wireless devices to communicate with other wired devices. This collection of network gear is referred to as WiFi Routers 130, 131 in the present art.

Wireless adapters (not shown) allow WiFi-enabled devices, such as, but not limited to Cell Phones 140, 141, to connect to a wireless network, illustrated as WiFi Routers 130, 131 in FIG. 1. These wireless adapters (not shown) connect to devices using various external or internal interconnects such as PCI, miniPCI, USB, ExpressCard, Cardbus and PC Card. Since 2010, most laptop computers (not shown) come equipped with built in internal adapters.

Wireless routers integrate a Wireless Access Point, Ethernet switch, and internal router firmware application that provides IP routing, NAT, and DNS forwarding through an integrated WAN-interface. A wireless router allows wired and wireless Ethernet LAN devices to connect to a (usually) single WAN device such as a cable modem or a DSL modem. A wireless router allows all three devices, mainly the access point and router, to be configured through one central utility. This utility is usually an integrated web server that is accessible to wired and wireless LAN clients and often optionally to WAN clients. This utility may also be an application that is run on a computer, as is the case with as Apple's AirPort, which is managed with the AirPort Utility on macOS and iOS.

Wireless network bridges (not shown) connect a wired network to a wireless network. A bridge differs from an access point: an access point connects wireless devices to a wired network at the data-link layer. Two wireless bridges (not shown) may be used to connect two wired networks over a wireless link, useful in situations where a wired connection may be unavailable, such as between two separate homes or for devices which do not have wireless networking capability (but have wired networking capability), such as consumer entertainment devices; alternatively, a wireless bridge can be used to enable a device which supports a wired connection to operate at a wireless networking standard which is faster than supported by the wireless network connectivity feature (external dongle or inbuilt) supported by the device, for example, enabling Wireless-N speeds (up to the maximum supported speed on the wired Ethernet port on both the bridge and connected devices including the wireless access point) for a device which only supports Wireless-G). A dual-band wireless bridge can also be used to enable 5 GHz wireless network operation on a device which only supports 2.4 GHz wireless networking functionality and has a wired Ethernet port.

Wireless range-extenders (not shown) or wireless repeaters (not shown) can extend the range of an existing wireless network.

Strategically placed range-extenders (not shown) can elongate a signal area or allow for the signal area to reach around barriers such as those pertaining in L-shaped corridors. Wireless devices, such as, but not limited to, Cell Phones 140, 141, connected through repeaters will suffer from an increased latency for each hop, as well as from a reduction in the maximum data throughput that is available. In addition, the effect of additional users using a network employing wireless range-extenders is to consume the available bandwidth faster than would be the case where, but a single user migrates around a network employing extenders. For this reason, wireless range-extenders (not shown) work best in networks supporting very low traffic throughput requirements, such as for cases where but a single user with a WiFi equipped tablet (not shown) migrates around the combined extended and non-extended portions of the total connected network.

Additionally, a wireless device, such as, but not limited to Cell Phones 140, 141, connected to any of the repeaters (not shown) in the chain will have a data throughput that is also limited by the “weakest link” existing in the chain between where the connection originates and where the connection ends. Networks employing wireless extenders (not shown) are also more prone to degradation from interference from neighboring access points that border portions of the extended network and that happen to occupy the same channel as the extended network.

The security standard, WiFi Protected Setup, allows embedded devices with limited graphical user interface to connect to the Internet with ease. WiFi Protected Setup has 2 configurations: The Push Button configuration and the PIN configuration. These embedded devices are also called The Internet of Things and are low-power, battery-operated embedded systems. A number of WiFi manufacturers design chips and modules for embedded WiFi, such as GainSpan.

Increasingly in the last few years, embedded WiFi modules have become available that incorporate a real-time operating system and provide a simple means of wireless enabling any device which has and communicates via a serial port. This allows the design of simple monitoring devices. An example is a portable ECG device monitoring a patient at home. This WiFi-enabled device can communicate via the Internet.

These WiFi modules are designed by OEMs so that implementers need only minimal WiFi knowledge to provide WiFi connectivity for their products.

In 2014, Texas Instruments introduced the first ARM Cortex-M4 micro-controller with an on-board dedicated WiFi MCU, the SimpleLink CC3200. It makes embedded systems with WiFi connectivity possible to build as single-chip devices, which reduces their cost and minimum size, making it more practical to build wireless-networked controllers into inexpensive ordinary objects.

The WiFi signal range depends on the frequency band, radio power output, antenna gain and antenna type as well as the modulation technique. Line-of-sight is the thumbnail guide but reflection and refraction can have a significant impact.

An access point compliant with either 802.11b or 802.11g, using the stock antenna might have a range of 100 m (0.062 mi). The same radio with an external semi parabolic antenna (15 dB gain) might have a range over 20 miles.

Higher gain rating (dBi) indicates further deviation (generally toward the horizontal) from a theoretical, perfect isotropic radiator, and therefore the further the antenna can project a usable signal, as compared to a similar output power on a more isotropic antenna. For example, an 8 dBi antenna used with a 100 mW driver will have a similar horizontal range to a 6 dBi antenna being driven at 500 mW. Note that this assumes that radiation in the vertical is lost. This may not be the case in some situations, especially in large buildings or within a wave-guide. In the above example, a directional wave-guide. could cause the low power 6 dBi antenna to project much further in a single direction than the 8 dBi antenna which is not in a wave-guide., even if they are both being driven at 100 mW.

IEEE 802.11n, however, can more than double the range. Range also varies with frequency band. WiFi in the 2.4 GHz frequency block has slightly better range than WiFi in the 5 GHz frequency block used by 802.11a, and optionally by 802.11n. On Wireless Routers 130, 131 with detachable antennas, it is possible to improve range by fitting upgraded antennas which have higher gain in particular directions. Outdoor ranges can be improved to many kilometers through the use of high gain directional antennas at the router and remote device(s). In general, the maximum amount of power that a WiFi device can transmit is limited by local regulations, such as FCC Part 15 in the US. Equivalent isotropically radiated power (EIRP) in the European Union is limited to 20 dBm (100 mW).

To reach requirements for wireless LAN applications, WiFi has fairly high power consumption compared to some other standards.

Technologies such as Bluetooth, which is designed to support wireless personal area network (PAN) applications, provide a much shorter propagation range between 1 and 100 m and so in general have a lower power consumption. Other low-power technologies such as ZigBee have fairly long range, but much lower data rate. The high power consumption of WiFi makes battery life in mobile devices a concern.

There are a number of “no new wires” technologies to provide alternatives to WiFi for applications in which WiFi's indoor range is not adequate and where installing new wires (such as CAT-6) is not possible or cost-effective. For example, the ITU-TG.hn standard for high speed local area networks uses existing home wiring (coaxial cables, phone lines and power lines). Although G.hn does not provide some of the advantages of WiFi (such as mobility or outdoor use), it is designed for applications, such as IPTV distribution, where indoor range is more important than mobility.

Due to the complex nature of radio propagation at typical WiFi frequencies, particularly the effects of signal reflection off trees and buildings, algorithms can only approximately predict WiFi signal strength for any given area in relation to a transmitter. This effect does not apply equally to long-range WiFi, since longer links typically operate from towers that transmit above the surrounding foliage.

The practical range of WiFi essentially confines mobile use to such applications as inventory-taking machines (not shown) in warehouses or in retail spaces, barcode-reading devices (not shown) at check-out stands, or receiving/shipping stations. Mobile use of WiFi over wider ranges is limited, for instance, to uses such as in an automobile moving from one WiFi Router 130, 131 to another.

Increasing the number of WiFi Routers 130, 131 provides network redundancy, better range, support for fast roaming and increased overall network-capacity by using more channels or by defining smaller cells. Except for the smallest implementations, such as home or small office networks, WiFi implementations have moved toward “thin” access points, with more of the network intelligence housed in a centralized network appliance, relegating individual access points to the role of “dumb” transceivers. Outdoor applications may use mesh topologies.

When multiple access points are deployed they are often configured with the same SSID and security settings to form an “extended service set”. WiFi client devices will typically connect to the access point that can provide the strongest signal within that service set.

The point is, WiFi is an indispensable, and ubiquitous technology, in the present art of the modern world. WiFi is everywhere.

Com Paths 160, 161 may employ a combination of wired and wireless technologies, such as, but not limited to, Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhanced Network (iDEN), Communication protocols include, but are not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, GSM CSD, HSCSD, GPRS, UMTS, CDMA, TDMA, DSO, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and 00768, RVP over IP Remote Voice Protocol Over IP Specification, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), etc.

Com Paths 162, 163 are wireless cellular signals. There are a number of different digital cellular technologies, including, but not limited to, Global System for Mobile Communications (GSM), General Packet Radio Service (GPRS), cdmaOne, DMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN).

Com Paths 170, 171 may employ a combination of wired and wireless technologies. These wired and wireless technologies are described herein for Com Paths 160, 161.

Com Paths 180, 181 are wireless WiFi signals. There are two types of WiFi signals. 2.4 GHz, which is the lower frequency, this is the more common WiFi technology in use today. Many devices use it, so the signals can become more crowded and interfere with each other. It can pass through walls and windows fairly well. 5 GHz, which is the higher frequency technology is used by fewer devices and can sometimes achieve higher speeds because the frequencies are less crowded. It cannot pass through walls and windows as well as the 2.4 GHz band signals, so the range of 5 GHz technology is often shorter. These two types of WiFi are called the Frequency Bands, or just Bands for short.

Each frequency band used in WiFi is divided up into multiple “channels”.

For the 2.4 GHz band, there are 14 channels total. These channels overlap, so they aren't all usable at the same time. In a mesh network, all of the mesh links are set to the same channel.

The available 2.4 GHz channels vary depending on where you are in the world. For example, in the United States channels 12, 13 and 14 are not allowed for WiFi, as those frequencies are used by TV and satellite services. If you are building networks in the United States, you can only use channels 1 through 11. In the rest of the world, channel 1 through 13 is generally usable, and in a few places channel 14 is available.

The 5 GHz frequency band is much wider and has more channels. In the United States, the only channels available for building mesh networks are 36, 40, 44, 48, 149, 153, 157, 161, and 165. There are other channels available for WiFi Routers 130, 131, or other types of community networks, but those channels won't work with mesh wireless.

How does the network illustrated in FIG. 1 work to provide connection to data, or a website, located on Servers 110, 111, 112 in Cloud 100 that is being requested by a Cell Phone 140, 141?

There are usually two ways to connect to the Internet through Cell Phone 140, 141. One is via a cellular telephone service provider, or by using standard WiFi. WiFi enabled devices allow a person to surf the Web via free WiFi Routers 130, 131, also known as WiFi hot-spots.

Through a cellular service provider's Cell Networks 120, 121, a Cell Phone 140, 141 connects to the Internet, illustrated as Cloud 100 in FIG. 1, through data transfer using a wireless link. Cell Phones 140, 141 use a Wireless Application Protocol (WAP) to access data and services located on the Internet. WAP is the universal standard for wireless communications and applications.

For operating cell networks 120, 121, Global System for Mobile Communications (GSM) and Code Division Multiple Access (CDMA) are the most commonly deployed wireless access technologies. GSM and CDMA use different algorithms which allow multiple mobile phone users to share the same digital radio frequency without causing interfering for each other. Cell Phones 140, 141 have an in-built antenna (not shown) which is used to send packets of digital information back and forth with cell-phone towers via radio waves. Cell Phones 140, 141 connect to a cell tower (not shown) on Cell Networks 120, 121, and instead of connecting to another phone it connects to the Internet and can fetch or retrieve data.

The voice and data channels of Cell Phones 140, 141 are separated for maximum efficiency. Mobile Voice goes on one channel and IP or SMS signaling over Mobile Internet on another. The General Packet Radio Service (GPRS) network provides a gateway to the Internet through different frequency channels for uploading and downloading.

The transfer of data between a Cell Phone 140, 141 and the Cell Networks 120, 121 is Radio frequency (RF) energy which can be transmitted throughout a building passing through walls and other objects. This RF energy is transmitted to carry the information between your phone and the Internet. Modems gets the information onto and off the RF carrier by modulation and demodulation. The information through the RF carrier is sent in packets which have a source and destination address, which is very similar to the postal delivery service.

A router (not shown) on Cell Networks 120, 121 directs each packet to its destination and also provides a wireless access point to the Internet. A cell tower (not shown) on the Cell Networks 120, 121 is a wireless access point that enables sharing an Internet connection by letting several cellular-enabled devices, such as, but not limited to, Cell Phones 140, 141, tablets (not shown) laptop computers (not shown), etc., to wireless share Internet access through a single connection. An Internet Service Provider administers an Internet access point, such as, but not limited to a cell tower (not shown), which is accessible by cellular-enabled devices, such as, but not limited to, Cell Phones 140, 141 over long distances.

Different computer networks are linked through a common Internet protocol that lets them all speak the same language. To accomplish the same for Cell Networks 120, 121, WAP is used.

The mobile Internet mainly utilizes lightweight pages written in Extensible Hypertext Markup Language (XHTML) or Wireless Markup Language (WML) to deliver content to mobile devices. A markup language is used to add predefined tags or information to content which informs the device receiving the content what to do with it. WAP also allows the use of standard Internet protocols for smooth functioning of the Internet on various platforms.

When using a WAP-enabled device for Internet access to Servers 110, 111, 112 operating on Cloud 100, the cellular-enabled device, such as, but not limited to, Cell Phones 140, 141 sends out radio waves searching for a connection with the Cell Network's 120, 121 service provider. Once a connection is made, a request is sent to a gateway server (not shown) using WAP. This server (not shown) retrieves the required information from the website in HTTP (standard Internet protocol) form. The gateway server (not shown) converts the HTTP data to WML as it is compatible with the mobile web format. The converted WML data is then sent to the WAP client on the cellular-enabled device, such as, but not limited to, Cell Phones 140, 141 with the mobile Internet version of the required web-page. It is then passed to the web browser which acts as an interface between the mobile Internet and the user.

The WAP protocol stack determines the handshake between the gateway server and the WAP client. It also keeps data flow smooth, checks data integrity, authentication and encryption as well as adaptability to different network providers.

The SIM card in Cell Phones 140, 141 searches for a cellular signal. The connection manager software helps to establish a connection between the modem and a transmitting cell tower (not shown) that is part of Cell Networks 120, 121. After the sync is established, the data travels through the mobile signals in an encrypted format and reaches the cell tower (not shown). From the cell tower (not shown) it reaches the Internet Cloud 100 and fetches data from Servers 110, 111, 112. Mobile Broadband is one of the secured ways of data transmission as it works using a single IP address.

In the present art, free WiFi is commonly available in a lot of public places such as airports, cafes, college campuses etc. WiFi (IEEE 802.11 standard) enabled devices get connected to the Internet Cloud 100 through a WiFi Routers 130, 131 which requires telephone lines or Internet cables illustrated as Com Paths 170, 171 in FIG. 1, to reach Internet routers (not shown). The WiFi Router 130, 131 is a wireless network setup to allow guest access to the Internet. A user has more control over WiFi as it accesses an extension of a wired Local Area Network (LAN).

The LAN usually works over a small distance and might have a cable or radio link connecting the access point to an ISP through routers. WiFi operates at different frequency than Cell Networks 120, 121, and is less expensive to operate.

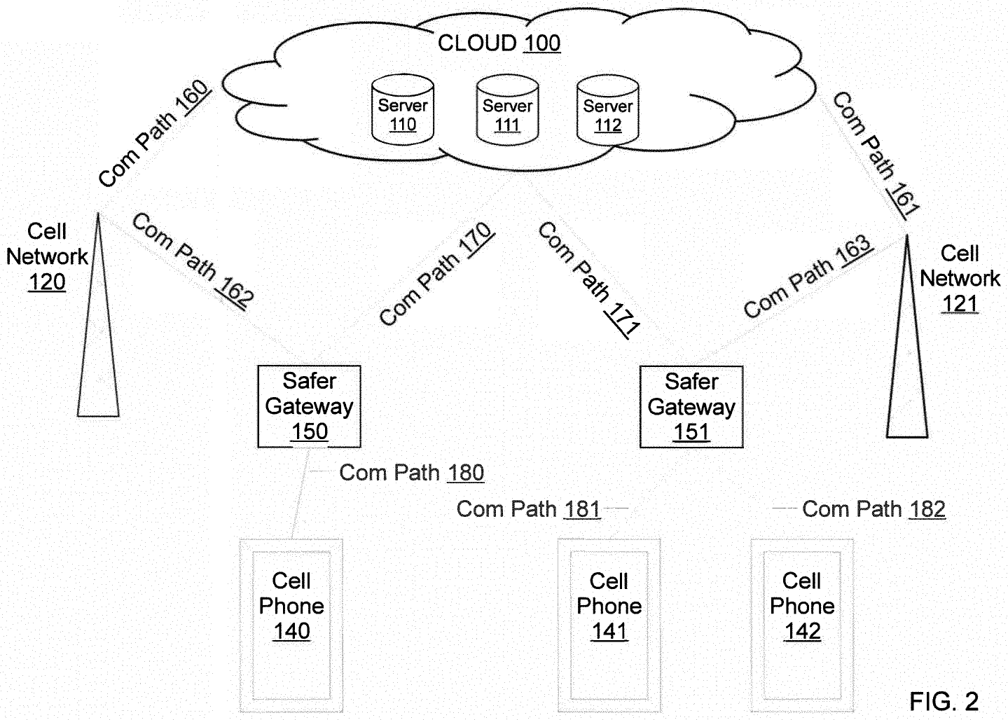

FIG. 2 is an illustration of the network topology of the preferred embodiment of the present invention.

Cloud 100, aka the Internet, is a global system of interconnected computer networks that use the Internet protocol suite (TCP/IP) to link several billion devices worldwide. It is a network of networks that consists of millions of private, public, academic, business, and government networks of local to global scope, linked by a broad array of electronic, wireless, and optical networking technologies. The Internet carries an extensive range of information resources and services, such as the inter-linked hypertext documents and applications of the World Wide Web (WWW), the infrastructure to support email, telephony, and peer-to-peer networks for file sharing.

Cloud 100 may be configured as a hybrid Cloud. A hybrid Cloud is a composite Cloud service that crosses the boundaries of private, public, and community Clouds that extends the capacity and capability, via aggregation and integration, of the composite Cloud service provided by the present invention. As an example, the present invention may store sensitive client data in house on a private Cloud application and interconnect that application to a business intelligence application provided on a public Cloud, as a software service. Monitoring framework integration, a Run-time Performance Manager and pervasive operational control with tools like Integration Bus Remote Control, Task Scheduler, Operational Dashboard, and a Representational State Transfer (REST) API for Management.

Cloud 100 includes Server 110, 111, 112. Server 110, 111, 112 are compute devices that run computer programs that provide functionality for other programs or devices, which are usually called “clients”. This architecture is called the client-server model, and a single overall computation is distributed across multiple processes or devices. Server 110, 111, 112 provide various functionalities, often called “services”, such as sharing data or resources among multiple clients, or performing computation for a client. A single server 110, 111, 112 can serve multiple clients, and a single client can use multiple Servers 110, 111, 112. A client process may run on the same device or may connect over a network to a server on a different device. Typical servers that may be used within the present invention include, but are not limited to, database servers, file servers, mail servers, print servers, web servers, and application servers.

Client-server systems usually use the “request-response model”. A client device, such as, but not limited to, Cell Phone 140, 141, 142 sends a request to a server 110, 111, 112, which performs some action and sends a response back to the client, typically with a result or acknowledgment.

The present invention includes a Cell Network 120, 121 infra-structure. A Cell Network 120, 121, also known as mobile network, is a communication network where the last communication link 162, 163 is wireless. The network is distributed over land areas called cells, each served by at least one fixed-location transceiver, but more normally three cell sites or base transceiver stations. These base stations provide the cell with the network coverage which can be used for transmission of voice, data and others. A cell typically uses a different set of frequencies from neighboring cells, to avoid interference and provide guaranteed service quality within each cell.

When joined together these cells provide radio coverage over a wide geographic area. This enables a large number of portable transceivers, such as, but not limited to, Cell Phones 140, 141, 142, tablets (not shown), laptops (not shown), or any device equipped with a mobile broadband modem, to communicate with each other and with fixed transceivers and telephones anywhere in the network, via base stations, even if some of the transceivers are moving through more than one cell during transmission.

Cell Networks 120, 121 are both voice and data cellular networks. They are designed to allow mobile Cell Phones 140, 141, 142 and mobile computing devices, such as, but not limited to, tablets (not shown), laptops (not shown), or any device equipped with a mobile broadband modem to be connected to the public switched telephone network (PSTN) and the public Internet. In addition, Cell Networks 120, 121 may be configured as private cell networks.

The present invention for telecommunicating voice and data also includes Safer Gateways 150, 151. Wi-Fi or WiFi is a technology for wireless local area networking with devices based on the IEEE 802.11 standards. WiFi is a trademark of the WiFi Alliance, which restricts the use of the term WiFi Certified to products that successfully complete inter-operability certification testing.

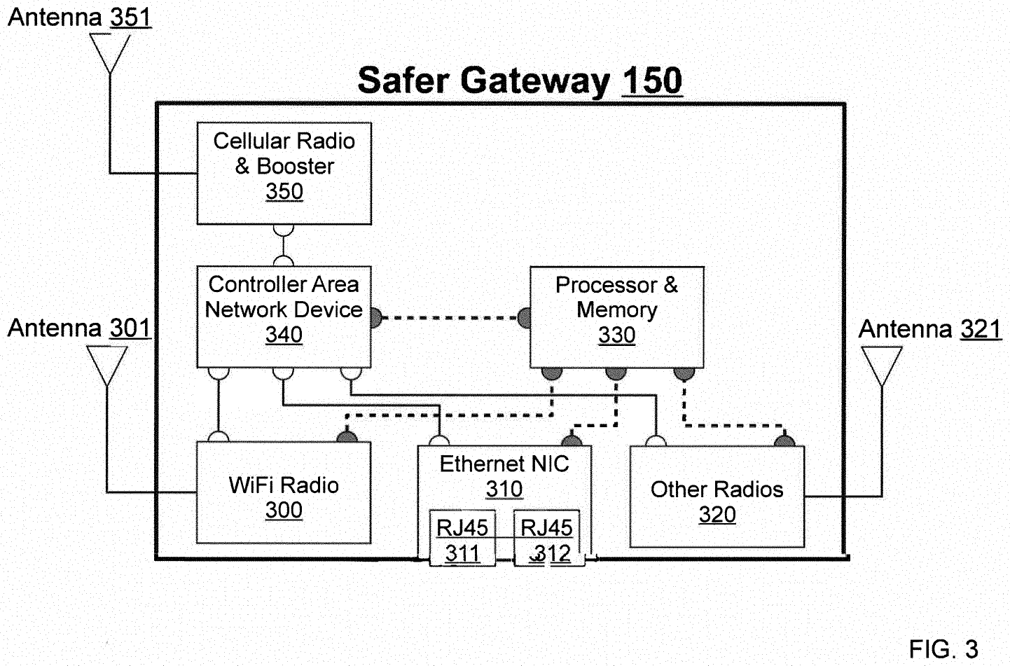

Devices that can use WiFi technology include, but is not limited to, personal computers (not shown), video-game consoles (not shown), Cell Phones 140, 141, 142, tablets (not shown), digital cameras (not shown), smart TVs (not shown), digital audio players (not shown), printers (not shown), etc. WiFi compatible devices can connect to the Internet via a WLAN and a wireless access point, described as Safer Gateways 150, 151. In the present invention, the term Safer Gateway 150 (as illustrated in FIG. 3) includes WiFi Routers, WiFi Antennae, and other network routers and switches that may comprise a WiFi network.

Safer Gateways 150, 151 typically have a range of about 20 to 100 meters, depending on whether the Safer Gateway 150, 151 is located indoors, or outdoors.

WiFi coverage can be as small as a single room with walls that block radio waves, or as large as many square kilometers achieved by using multiple overlapping access points.

WiFi most commonly uses the 2.4 gigahertz (12 cm) UHF and 5.8 gigahertz (5 cm) SHFISM radio bands. Anyone within range with a wireless modem can attempt to access the network. WiFi is more vulnerable to attack (called eavesdropping) than wired networks. WiFi Protected Access is a family of technologies created to protect information moving across WiFi networks and includes solutions for personal and enterprise networks. Security features of WiFi Protected Access constantly evolve to include stronger protections and new security practices as the security landscape changes. To connect to a WiFi LAN, a computer has to be equipped with a wireless network interface controller. The combination of computer and interface controller is called a station. For all stations that share a single radio frequency communication channel, transmissions on this channel are received by all stations within range. The transmission is not guaranteed to be delivered and is therefore a best-effort delivery mechanism. A carrier wave is used to transmit the data. The data is organized in packets on an Ethernet link, referred to as “Ethernet frames”.

WiFi technology may be used to provide Internet access to devices that are within the range of a wireless network that is connected to the Internet. The coverage of one or more interconnected Safer Gateways 150, 151 can extend from an area as small as a few rooms to as large as many square kilometers. Coverage in the larger area may require a group of Safer Gateways 150, 151 access points with overlapping coverage.

WiFi technology provides service in private homes, businesses, as well as in public spaces at WiFi Router 130, 131 are set up either free-of-charge or commercially, which often use captive portal webpages to gain access. Organizations and businesses, such as airports, hotels, and restaurants, often provide free-use hot-spots. to attract customers. Enthusiasts or authorities who wish to provide services or even to promote business in selected areas sometimes provide free WiFi access.

When subscribed to a cellular data carrier, devices such as, but not limited to Cell Phones 140, 141, 142, tablets (not shown), etc., allow nearby WiFi stations to access the Internet over 2G, 3G, or 4G networks using a tethering technique. Many Cell Phones 140, 141, 142 now have a built-in capability of this sort, including, but not limited to, those based on Android, BlackBerry, Bada, iOS (iPhone), Windows Phone and Symbian, though carriers often disable the feature, or charge a separate fee to enable it, especially for customers with unlimited data plans.

“Internet packs” provide standalone facilities of this type as well, without use of a smartphone; examples include the MiFi- and WiBro-branded devices. Some laptops (not shown) that have a cellular modem card can also act as mobile Internet WiFi Router.

WiFi also allows communications directly from one computer to another without an access point intermediary. This is called ad hoc WiFi transmission. This wireless ad hoc network mode has proven popular with multiplayer handheld game consoles, such as, but not limited to, the Nintendo DS, PlayStation Portable (not shown), digital cameras (not shown), and other consumer electronics devices.

In addition to running on different channels, multiple WiFi networks can share channels.

A WiFi signal occupies five channels in the 2.4 GHz band. Any two channel numbers that differ by five or more, such as 2 and 7, do not overlap. The oft-repeated adage that channels 1, 6, and 11 are the only non-overlapping channels is, therefore, not accurate. Channels 1, 6, and 11 are the only group of three non-overlapping channels in North America and the United Kingdom. In Europe and Japan using Channels 1, 5, 9, and 13 for 802.11g and 802.11n is recommended.

802.11a uses the 5 GHz U-NII band, which, for much of the world, offers at least 23 non-overlapping channels rather than the 2.4 GHz ISM frequency band, where adjacent channels overlap.

WiFi connections can be disrupted or the Internet speed lowered by having other devices in the same area. Many 2.4 GHz 802.11b and 802.11g access-points default to the same channel on initial startup, contributing to congestion on certain channels. WiFi pollution, or an excessive number of Safer Gateways 150, 151 (as illustrated in FIG. 3) in the area, especially on the neighboring channel, can prevent access and interfere with other devices' use of other access points, caused by overlapping channels in the 802.11g/b spectrum, as well as with decreased signal-to-noise ratio (SNR) between access points. This can become a problem in high-density areas, such as large apartment complexes or office buildings with many WiFi Routes 130, 131

Additionally, other devices (not shown) use the 2.4 GHz band: microwave ovens, ISM band devices, security cameras, ZigBee devices, Bluetooth devices, video senders, cordless phones, baby monitors, and, in some countries, amateur radio, all of which can cause significant additional interference. It is also an issue when municipalities or other large entities, such as, but not limited to a university campus, seek to provide large area coverage.

A service set is the set of all the devices associated with a particular WiFi network. The service set can be local, independent, extended or mesh. Each service set has an associated identifier, the 32-byte Service Set Identifier (SSID), which identifies the particular network. The SSID is configured within the devices that are considered part of the network, and it is transmitted in the packets. Receivers ignore wireless packets from networks with a different SSID.

As the 802.11 specifications evolved to support higher throughput, the bandwidth requirements also increased to support them. 802.11n uses double the radio spectrum/bandwidth (40 MHz) compared to 802.11a or 802.11g (20 MHz). This means there can be only one 802.11n network on the 2.4 GHz band at a given location, without interference to/from other WLAN traffic. 802.11n can also be set to limit itself to 20 MHz bandwidth to prevent interference in dense community.

Many consumer devices (not shown) support the latest 802.11ac standard, which uses the 5 GHz band exclusively and is capable of multi-station WLAN throughput of at least 1 gigabit per second, and a single station throughput of at least 500 Mbit/s. In the first quarter of 2016,

The WiFi Alliance certifies devices compliant with the 802.11ac standard as “WiFi CERTIFIED ac”. This new standard uses several advanced signal processing techniques such as multi-user MIMO and 4×4 Spatial Multiplexing streams, and large channel bandwidth (160 MHz) to achieve the Gigabit throughput.

WiFi allows wireless deployment of local area networks (LANs). Also, spaces where cables cannot be run, such as outdoor areas and historical buildings, can host wireless LANs. However, building walls of certain materials, such as stone with high metal content, can block WiFi signals.

A wireless access point (WAP) connects a group of wireless devices to an adjacent wired LAN. An access point resembles a network hub, relaying data between connected wireless devices in addition to a (usually) single connected wired device, most often an Ethernet hub or switch, allowing wireless devices to communicate with other wired devices. This collection of network gear is referred to as Safer Gateways 150, 151 (as illustrated in FIG. 3) in the present art.

Wireless adapters (not shown) allow WiFi-enabled devices, such as, but not limited to Cell Phones 140, 141, 142, to connect to a wireless network, illustrated as Safer Gateways 150, 151 (as illustrated in FIG. 3) in FIG. 3. These wireless adapters (not shown) connect to devices using various external or internal interconnects such as PCI, miniPCI, USB, ExpressCard, Cardbus and PC Card. Since 2010, most laptop computers (not shown) come equipped with built in internal adapters.

Wireless routers integrate a Wireless Access Point, Ethernet switch, and internal router firmware application that provide IP routing, NAT, and DNS forwarding through an integrated WAN-interface. A wireless router allows wired and wireless Ethernet LAN devices to connect to a (usually) single WAN device such as a cable modem or a DSL modem. A wireless router allows all three devices, mainly the access point and router, to be configured through one central utility. This utility is usually an integrated web server that is accessible to wired and wireless LAN clients and often optionally to WAN clients. This utility may also be an application that is run on a computer, as is the case with as Apple's AirPort, which is managed with the AirPort Utility on macOS and iOS.

Wireless network bridges (not shown) connect a wired network to a wireless network. A bridge differs from an access point: an access point connects wireless devices to a wired network at the data-link layer. Two wireless bridges (not shown) may be used to connect two wired networks over a wireless link, useful in situations where a wired connection may be unavailable, such as between two separate homes or for devices which do not have wireless networking capability (but have wired networking capability), such as consumer entertainment devices; alternatively, a wireless bridge can be used to enable a device which supports a wired connection to operate at a wireless networking standard which is faster than supported by the wireless network connectivity feature (external dongle or inbuilt) supported by the device, for example, enabling Wireless-N speeds (up to the maximum supported speed on the wired Ethernet port on both the bridge and connected devices including the wireless access point) for a device which only supports Wireless-G). A dual-band wireless bridge can also be used to enable 5 GHz wireless network operation on a device which only supports 2.4 GHz wireless networking functionality and has a wired Ethernet port.

Wireless range-extenders (not shown) or wireless repeaters (not shown) can extend the range of an existing wireless network.

Strategically placed range-extenders (not shown) can elongate a signal area or allow for the signal area to reach around barriers such as those pertaining in L-shaped corridors. Wireless devices, such as, but not limited to, Cell Phones 140, 141, 142, connected through repeaters will suffer from an increased latency for each hop, as well as from a reduction in the maximum data throughput that is available. In addition, the effect of additional users using a network employing wireless range-extenders is to consume the available bandwidth faster than would be the case where but a single user migrates around a network employing extenders. For this reason, wireless range-extenders (not shown) work best in networks supporting very low traffic throughput requirements, such as for cases where but a single user with a WiFi equipped tablet (not shown) migrates around the combined extended and non-extended portions of the total connected network.

Additionally, a wireless device, such as, but not limited to Cell Phones 140, 141, 142, connected to any of the repeaters (not shown) in the chain will have a data throughput that is also limited by the “weakest link” existing in the chain between where the connection originates and where the connection ends. Networks employing wireless extenders (not shown) are also more prone to degradation from interference from neighboring access points that border portions of the extended network and that happen to occupy the same channel as the extended network.

The security standard, WiFi Protected Setup, allows embedded devices with limited graphical user interface to connect to the Internet with ease. WiFi Protected Setup has 2 configurations: The Push Button configuration and the PIN configuration. These embedded devices are also called The Internet of Things and are low-power, battery-operated embedded systems. A number of WiFi manufacturers design chips and modules for embedded WiFi, such as GainSpan.

Increasingly in the last few years, embedded WiFi modules have become available that incorporate a real-time operating system and provide a simple means of wireless enabling any device which has and communicates via a serial port. This allows the design of simple monitoring devices. An example is a portable ECG device monitoring a patient at home. This WiFi-enabled device can communicate via the Internet.

These WiFi modules are designed by OEMs so that implementers need only minimal WiFi knowledge to provide WiFi connectivity for their products.

In 2014, Texas Instruments introduced the first ARM Cortex-M4 micro-controller with an on-board dedicated WiFi MCU, the SimpleLink CC3200. It makes embedded systems with WiFi connectivity possible to build as single-chip devices, which reduces their cost and minimum size, making it more practical to build wireless-networked controllers into inexpensive ordinary objects.

The WiFi signal range depends on the frequency band, radio power output, antenna gain and antenna type as well as the modulation technique. Line-of-sight is the thumbnail guide but reflection and refraction can have a significant impact.

An access point compliant with either 802.11b or 802.11g, sing the stock antenna might have a range of 100 m (0.062 mi). The same radio with an external semi parabolic antenna (15 dB gain) might have a range over 20 miles.

Higher gain rating (dBi) indicates further deviation (generally toward the horizontal) from a theoretical, perfect isotropic radiator, and therefore the further the antenna can project a usable signal, as compared to a similar output power on a more isotropic antenna. For example, an 8 dBi antenna used with a 100 mW driver will have a similar horizontal range to a 6 dBi antenna being driven at 500 mW. Note that this assumes that radiation in the vertical is lost. This may not be the case in some situations, especially in large buildings or within a wave-guide. In the above example, a directional wave-guide. could cause the low power 6 dBi antenna to project much further in a single direction than the 8 dBi antenna which is not in a wave-guide., even if they are both being driven at 100 mW.

IEEE 802.11n, however, can more than double the range. Range also varies with frequency band. WiFi in the 2.4 GHz frequency block has slightly better range than WiFi in the 5 GHz frequency block used by 802.11a, and optionally by 802.11n. On Wireless Routers 130, 131 with detachable antennas, it is possible to improve range by fitting upgraded antennas which have higher gain in particular directions. Outdoor ranges can be improved to many kilometers through the use of high gain directional antennas at the router and remote device(s). In general, the maximum amount of power that a WiFi device can transmit is limited by local regulations, such as FCC Part 15 in the US. Equivalent isotropically radiated power (EIRP) in the European Union is limited to 20 dBm (100 mW).

To reach requirements for wireless LAN applications, WiFi has fairly high power consumption compared to some other standards.

Technologies such as Bluetooth, which is designed to support wireless personal area network (PAN) applications, provide a much shorter propagation range between 1 and 100 m and so in general have lower power consumption. Other low-power technologies such as ZigBee have fairly long range, but much lower data rate. The high power consumption of WiFi makes battery life in mobile devices a concern.

There are a number of “no new wires” technologies to provide alternatives to WiFi for applications in which WiFi's indoor range is not adequate and where installing new wires (such as CAT-6) is not possible or cost-effective. For example, the ITU-TG.hn standard for high speed local area networks uses existing home wiring (coaxial cables, phone lines and power lines). Although G.hn does not provide some of the advantages of WiFi (such as mobility or outdoor use), it is designed for applications, such as IPTV distribution, where indoor range is more important than mobility.

Due to the complex nature of radio propagation at typical WiFi frequencies, particularly the effects of signal reflection off trees and buildings, algorithms can only approximately predict WiFi signal strength for any given area in relation to a transmitter. This effect does not apply equally to long-range WiFi, since longer links typically operate from towers that transmit above the surrounding foliage.

The practical range of WiFi essentially confines mobile use to such applications as inventory-taking machines (not shown) in warehouses or in retail spaces, barcode-reading devices (not shown) at check-out stands, or receiving/shipping stations. Mobile use of WiFi over wider ranges is limited, for instance, to uses such as in an automobile moving from one Safer Gateways 150, 151 to another.

Increasing the number of WiFi Routers provides network redundancy, better range, support for fast roaming and increased overall network-capacity by using more channels or by defining smaller cells. Except for the smallest implementations, such as home or small office networks, WiFi implementations have moved toward “thin” access points, with more of the network intelligence housed in a centralized network appliance, relegating individual access points to the role of “dumb” transceivers. Outdoor applications may use mesh topologies.

When multiple access points are deployed they are often configured with the same SSID and security settings to form an “extended service set”. WiFi client devices will typically connect to the access point that can provide the strongest signal within that service set.

Com Paths 160, 161 may employ a combination of wired and wireless technologies. These technologies are described herein in FIG. 1 Com Paths 160, 161,

Com Paths 162, 163 are wireless cellular signals. These technologies are described herein in FIG. 1 Com Paths 162, 163.

Com Paths 170, 171 may employ a combination of wired and wireless technologies. These technologies are described herein in FIG. 1 Com Paths 160, 161,

Com Paths 180, 181 are wireless WiFi signals. There are two types of WiFi signals.

2.4 GHz, which is the lower frequency, this is the more common WiFi technology in use today. Many devices use it, so the signals can become more crowded and interfere with each other. It can pass through walls and windows fairly well.

5 GHz, which is the higher frequency technology is used by fewer devices, and can

sometimes achieve higher speeds because the frequencies are less crowded. It cannot pass through walls and windows as well as the 2.4 GHz band signals, so the range of 5 GHz technology is often shorter.

These two types of WiFi are called the Frequency Bands, or just Bands for short.

Each frequency band used in WiFi is divided up into multiple “channels”.

For the 2.4 GHz band, there are 14 channels total. These channels overlap, so they aren't all usable at the same time. In a mesh network, all of the mesh links are set to the same channel.

The available 2.4 GHz channels vary depending on where you are in the world. For example, in the United States channels 12, 13 and 14 are not allowed for WiFi, as those frequencies are used by TV and satellite services. If you are building networks in the United States, you can only use channels 1 through 11. In the rest of the world, channels 1 through 13 are generally usable, and in a few places channel 14 is available.

The 5 GHz frequency band is much wider and has more channels. In the United States, the only channels available for building mesh networks are 36, 40, 44, 48, 149, 153, 157, 161, and 165. There are other channels available for Safer Gateways 150, 151 (as illustrated in FIG. 3), or other types of community networks, but those channels won't work with mesh wireless.

How does the network illustrated in FIG. 2 work to provide connection to data, or a website, located on Servers 110, 111, 112 in Cloud 100 that is being requested by a Cell Phone 140, 141, 142.

There are usually two ways to connect to the Internet through Cell Phone 140, 141, 142. One is via a cellular telephone service provider, or by using standard WiFi. WiFi enabled devices allows a person to surf the Web via free Safer Gateways 150, 151, also known as WiFi hot-spots. Through a cellular service provider's Cell Networks 120, 121, a Cell Phone 140, 141, 142 connects to the Internet, illustrated as Cloud 100 in FIG. 2, through data transfer using a wireless link. Cell Phones 140, 141, 142 use a Wireless Application Protocol (WAP) to access data and services located on the Internet. WAP is the universal standard for wireless communications and applications.

For operating cell networks 120, 121, Global System for Mobile Communications (GSM) and Code Division Multiple Access (CDMA) are the most commonly deployed wireless access technologies. GSM and CDMA use different algorithms which allow multiple mobile phone users to share the same digital radio frequency without causing interfering for each other. Cell Phones 140, 141, 142 have an in-built antenna (not shown) which is used to send packets of digital information back and forth with cell-phone towers via radio waves. Cell phones 140, 141, 142 connect to a cell tower (not shown) on cell networks 120, 121, and instead of connecting to another phone it connects to the Internet and can fetch or retrieve data.

The voice and data channels of Cell Phones 140, 141, 142 are separated for maximum efficiency. Mobile Voice goes on one channel and IP or SMS signaling over Mobile Internet on another. The General Packet Radio Service (GPRS) network provides a gateway to the Internet through different frequency channels for uploading and downloading.

The transfer of data between a Cell Phone 140, 141, 142 and the Cell Network 120, 121 is Radio frequency (RF) energy which can be transmitted throughout a building passing through walls and other objects. This RF energy is transmitted to carry the information between cell phone 140, 141, 142 and the Internet. Modems get the information onto and off the RF carrier by modulation and demodulation. The information through the RF carrier is sent in packets which have a source and destination address, which is very similar to the postal delivery service.

A router (not shown) on Cell Network 120, 121 directs each packet to its destination and also provides a wireless access point to the Internet. A cell tower (not shown) on Cell Networks 120, 121 is a wireless access point that enables sharing an Internet connection by letting several cellular-enabled devices, such as, but not limited to, Cell Phones 140, 141, 142, tablets (not shown) laptop computers (not shown), etc., to wireless share Internet access through a single connection. An Internet Service Provider administers an Internet access point, such as, but not limited to a cell tower (not shown), which is accessible by cellular-enabled devices, such as, but not limited to, Cell Phones 140, 141, 142 over long distances.

Different computer networks are linked through a common Internet protocol that lets them all speak the same language. To accomplish the same for Cell Networks 120, 121, WAP is used.

The mobile Internet mainly utilizes lightweight pages written in Extensible Hypertext Markup Language (XHTML) or Wireless Markup Language (WML) to deliver content to mobile devices. A markup language is used to add predefined tags or information to content which informs the device receiving the content what to do with it. WAP also allows the use of standard Internet protocols for smooth functioning of the Internet on various platforms.

When using a WAP-enabled device for Internet access to Servers 110, 111, 112 operating on Cloud 100, the cellular-enabled device, such as, but not limited to, Cell Phones 140, 141, 142 sends out radio waves searching for a connection with the Cell Network's 120, 121 service provider. Once a connection is made, a request is sent to a gateway server (not shown) using WAP. This server (not shown) retrieves the required information from the website in HTTP (standard Internet protocol) form. The gateway server (not shown) converts the HTTP data to WML as it is compatible with the mobile web format. The converted WML data is then sent to the WAP client on the cellular-enabled device, such as, but not limited to, Cell Phones 140, 141, 142 with the mobile Internet version of the required web-page. It is then passed to the web browser which acts as an interface between the mobile Internet and the user.

The WAP protocol stack determines the handshake between the gateway server and the WAP client. It also keeps data flow smooth, checks data integrity, authentication and encryption as well as adaptability to different network providers.

The SIM card in Cell Phones 140, 141, 142 searches for a cellular signal. The connection manager software helps to establish a connection between the modem and a transmitting cell tower (not shown) that is part of Cell Networks 120, 121. After the sync is established, the data travels through the mobile signals in an encrypted format and reaches the cell tower (not shown). From the cell tower (not shown) it reaches the Internet Cloud 100 and fetches data from Servers 110, 111, 112. Mobile Broadband is one of the secured ways of data transmission as it works using a single IP address.

In the present art, free WiFi is commonly available in a lot of public places such as airports, cafes, college campuses etc. WiFi (IEEE 802.11 standard) enabled devices get connected to the Internet Cloud 100 through a Safer Gateway 150, which requires telephone lines or Internet cables illustrated as Com Paths 170, 171 in FIG. 2, to reach Internet routers (not shown). The WiFi Router 130, 131 (as shown in FIG. 1) is a wireless network setup to allow guest access to the Internet. A user has more control over WiFi as it accesses an extension of a wired Local Area Network (LAN). The LAN usually works over a small distance and might have a cable or radio link connecting the access point to an ISP through routers. WiFi operates at different frequency than Cell Networks 120, 121, and is less expensive to operate.

FIG. 3 is a block diagram of the preferred embodiment of the present invention's Safer Gateway device.

Safer Gateway 150 is comprised of the following components at a minimum, but other components may be added as necessary for proper operation within the preferred embodiment of the present invention.

Safer Gateway 150, includes WiFi Radio 300. Wi-Fi or WiFi is a technology for wireless local area networking with devices based on the IEEE 802.11 standards. WiFi is a trademark of the WiFi Alliance, which restricts the use of the term WiFi Certified to products that successfully complete inter-operability certification testing.

WiFi Radio 300 (as illustrated in FIG. 3) typically has a range of about 20 to 100 meters, depending on whether the Safer Gateways 150 (as illustrated in FIG. 3) is located indoors, or outdoors.

WiFi coverage can be as small as a single room with walls that block radio waves, or as large as many square kilometers achieved by using multiple overlapping access points.

WiFi most commonly uses the 2.4 gigahertz (12 cm) UHF and 5.8 gigahertz (5 cm) SHFISM radio bands. Anyone within range with a wireless modem can attempt to access the network. WiFi is more vulnerable to attack (called eavesdropping) than wired networks. WiFi Protected Access is a family of technologies created to protect information moving across WiFi networks and includes solutions for personal and enterprise networks. Security features of WiFi Protected Access constantly evolve to include stronger protections and new security practices as the security landscape changes. To connect to a WiFi LAN, a computer has to be equipped with a wireless network interface controller.

The combination of computer and interface controller is called a station. For all stations that share a single radio frequency communication channel, transmissions on this channel are received by all stations within range. The transmission is not guaranteed to be delivered and is therefore a best-effort delivery mechanism. A carrier wave is used to transmit the data. The data is organized in packets on an Ethernet link, referred to as “Ethernet frames”.

WiFi technology may be used to provide Internet access to devices that are within the range of a wireless network that is connected to the Internet. The coverage of one or more interconnected Safer Gateways 150, 151 (as illustrated in FIG. 2) can extend from an area as small as a few rooms to as large as many square kilometers. Coverage in the larger area may require a group of Safer Gateways 150, 151 (as illustrated in FIG. 2) access points with overlapping coverage.

WiFi technology provides service in private homes, businesses, as well as in public spaces, as a Safer Gateway 150 can be set up either free-of-charge or commercially, which often use captive portal webpages to gain access. Organizations and businesses, such as airports, hotels, and restaurants, often provide free-use hot-spots. to attract customers. Enthusiasts or authorities who wish to provide services or even to promote business in selected areas sometimes provide free WiFi access.

Routers that incorporate a digital subscriber line modem (DSL) or a cable modem and a Safer Gateway 150 set up in homes and other buildings, provide Internet access and inter-networking to all devices connected to them, wireless or via cable.

When subscribed to a cellular data carrier, these devices such as, but not limited to Cell Phones 140, 141, 142 (shown in FIG. 2), tablets (not shown), etc., allow nearby WiFi stations to access the Internet over 2G, 3G, or 4G networks using a tethering technique. Many Cell Phones 140, 141, 142 now have a built-in capability of this sort, including, but not limited to, those based on Android, BlackBerry, Bada, iOS (iPhone), Windows Phone and Symbian, though carriers often disable the feature, or charge a separate fee to enable it, especially for customers with unlimited data plans. “Internet packs” provide standalone facilities of this type as well, without use of a smartphone; examples include the MiFi and WiBro-branded devices

Safer Gateway 150 includes Ethernet NIC 310. Ethernet NIC 310 is a Network Interface Controller (NIC, also known as a network interface card, network adapter, LAN adapter or physical network interface and by similar terms) is a computer hardware component that connects a computer to a computer network via hard-wire connection via RJ45s 311, 312.

RJ45s 311, 312 are electrical connectors. An electrical connector is an electro-mechanical device used to join electrical terminations and create an electrical circuit. RJ45s 311, 312 are jacks (female-ended), used to connect to computer cables, such as CAT-5, CAT-6, CAT-7, which include male-ended plugs.

Modern network interface controllers offer advanced features such as interrupt and DMA interfaces to the host processors, support for multiple receive and transmit queues, partitioning into multiple logical interfaces, and on-controller network traffic processing such as the TCP offload engine.

The network controller implements the electronic circuitry required to communicate using a specific physical layer and data link layer standard such as Ethernet or WiFi.

This provides a base for a full network protocol stack, allowing communication among computers on the same local area network (LAN) and large-scale network communications through routing protocols, such as Internet Protocol (IP).

The NIC allows computers to communicate over a computer network, either by using cables or wireless. The NIC is both a physical layer and data link layer device, as it provides physical access to a networking medium and, for IEEE 802 and similar networks, provides a low-level addressing system through the use of MAC addresses that are uniquely assigned to network interfaces.

The NIC may use one or more of the following techniques to indicate the availability of packets to transfer:

1) Polling is where the CPU examines the status of the peripheral under program control.

2) Interrupt-driven I/O is where the peripheral alerts the CPU that it is ready to transfer data.

Also, NICs may use one or more of the following techniques to transfer packet data:

1) Programmed input/output is where the CPU moves the data to or from the NIC to memory.

2) Direct memory access (DMA) is where some other device other than the CPU assumes control of the system bus to move data to or from the NIC to memory. This removes load from the CPU but requires more logic on the card. In addition, a packet buffer on the NIC may not be required and latency can be reduced.

An Ethernet network controller typically has an 8P8C socket where the network cable is connected. Older NICs also supplied BNC, or AUI connections. Ethernet network controllers typically support 10 Mbit/s Ethernet, 100 Mbit/s Ethernet, and 1000 Mbit/s Ethernet varieties.

Such controllers are designated as “10/100/1000”, meaning that they can support a notional maximum transfer rate of 10, 100 or 1000 Mbit/s. 10 Gigabit Ethernet NICs are also available, and, as of November 2014, are beginning to be available on computer motherboards.

In addition to embedding the physical port into the NIC, modular designs like SFP and SFP+ are highly popular, especially for fiber-optic communication. These define a standard receptacle for media-dependent transceivers, so users can easily adapt the network interface to their needs.

As an example, Intel 82574L Gigabit Ethernet NIC, a PCI Express×1 card, which provides two hardware receive queues.

Multi-queue NICs provide multiple transmit and receive queues, allowing packets received by the NIC to be assigned to one of its receive queues. Each receive queue is assigned to a separate interrupt; by routing each of those interrupts to different CPUs/cores, processing of the interrupt requests triggered by the network traffic received by a single NIC can be distributed among multiple cores, bringing additional performance improvements in interrupt handling. Usually, a NIC distributes incoming traffic between the receive queues using a hash function, while separate interrupts can be routed to different CPUs/cores either automatically by the operating system, or manually by configuring the IRQ affinity.

The hardware-based distribution of the interrupts, described above, is referred to as receive-side scaling (RSS). Purely software implementations also exist, such as the receive packet steering (RPS) and receive flow steering (RFS). Further performance improvements can be achieved by routing the interrupt requests to the CPUs/cores executing the applications which are actually the ultimate destinations for network packets that generated the interrupts. That way, taking the application locality into account results in higher overall performance, reduced latency and better hardware utilization, resulting from the higher utilization of CPU caches and fewer required context switches. Examples of such implementations are the RFS and Intel Flow Director.

With multi-queue NICs, additional performance improvements can be achieved by distributing outgoing traffic among different transmit queues. By assigning different transmit queues to different CPUs/cores, various operating systems' internal contentions can be avoided; this approach is usually referred to as transmit packet steering (XPS).

Some NICs support transmit and receive queues without kernel support allowing the NIC to execute even when the functionality of the operating system of a critical system has been severely compromised. Those NICs support:

1) Accessing local and remote memory without involving the remote CPU.

2) Accessing local and remote I/O devices without involving local/remote CPU. This capability is supported by device-to-device communication over the I/O bus, present in switched-based I/O interconnects.

3) Controlling access to local resources such as control registers and memory.

Some products feature NIC partitioning (NPAR, also known as port partitioning) that uses SR-IOV to divide a single 10 Gigabit Ethernet NIC into multiple discrete virtual NICs with dedicated bandwidth, which are presented to the firmware and operating system as separate PCI device functions. TCP offload engine is a technology used in some NICs to offload processing of the entire TCP/IP stack to the network controller. It is primarily used with high-speed network interfaces, such as Gigabit Ethernet and 10 Gigabit Ethernet, for which the processing overhead of the network stack becomes significant.

Some NICs offer integrated field-programmable gate arrays (FPGAs) for user-programmable processing of network traffic before it reaches the host computer, allowing for significantly reduced latencies in time-sensitive workloads. Moreover, some NICs offer complete low-latency TCP/IP stacks running on integrated FPGAs in combination with user space libraries that intercept networking operations usually performed by the operating system kernel; Solarflare's open-source OpenOnload network stack that runs on Linux is an example. This kind of functionality is usually referred to as user-level networking.

Safer Gateway 150, includes Other Radios 320. Other Radios 320 can be configured to receive and/or transmit signals compatible with standards such as, but not limited to, Bluetooth, ZigBee, Z-Wave, FM radio, AM radio, etc.

Safer Gateway 150, includes Processor and Memory 330. A microprocessor is a computer processor that incorporates the functions of a central processing unit on a single integrated circuit (IC), or at most a few integrated circuits. The microprocessor is a multipurpose, clock driven, register based, digital-integrated circuit that accepts binary data as input, processes it according to instructions stored in its memory, and provides results as output. Microprocessors contain both combinational logic and sequential digital logic. Microprocessors operate on numbers and symbols represented in the binary numeral system.

The integration of a whole CPU onto a single chip or on a few chips greatly reduces the cost of processing power, and increases efficiency. Single-chip processors increase reliability because there are many fewer electrical connections to fail.

Memory refers to the computer hardware integrated circuits that store information for immediate use in a computer; it is synonymous with the term “primary storage”. Computer memory operates at a high speed, for example random-access memory (RAM), as a distinction from storage that provides slow-to-access information but offers higher capacities. If needed, contents of the computer memory can be transferred to secondary storage, through a memory management technique called “virtual memory”.

The term “memory”, meaning “primary storage” or “main memory”, is often associated with addressable semiconductor memory, i.e. integrated circuits consisting of silicon-based transistors, used for example as primary storage but also other purposes in computers and other digital electronic devices. There are two main kinds of semiconductor memory, volatile and non-volatile. Examples of non-volatile memory are flash memory (used as secondary memory) and ROM, PROM, EPROM and EEPROM memory (used for storing firmware such as BIOS).

Examples of volatile memory are primary storage, which is typically dynamic random-access memory (DRAM), and fast CPU cache memory, which is typically static random-access memory (SRAM) that is fast but energy-consuming, offering lower memory areal density than DRAM.

Most semiconductor memory is organized into memory cells or bitable flip-flops, each storing one bit (0 or 1). Flash memory organization includes both one bit per memory cell and multiple bits per cell (called MLC, Multiple Level Cell). The memory cells are grouped into words of fixed word length, for example 1, 2, 4, 8, 16, 32, 64 or 128 bit. Each word can be accessed by a binary address of N bit, making it possible to store 2 raised by N words in the memory. This implies that processor registers normally are not considered as memory, since they only store one word and do not include an addressing mechanism.

Safer Gateway 150, includes Generic Access Network Device 340. A Generic Access Network (GAN) is a telecommunication system which extends mobile services voice, data and IP Multimedia Subsystem/Session Initiation Protocol (IMS/SIP) applications over IP access networks. The Generic Access Network (GAN) is an evolving wireless communications system in which mobile phone sets function seamlessly between local area networks (LANs) and wide-area networks (WANs). Using GAN technology, a cell phone subscriber can communicate by voice, data and multimedia without needing to use the cellular radio incorporated in their Cell Phone 140, 141, 142 (as illustrated in FIG. 2).

Safer Gateway 150, includes Cellular Radio and Booster 350. A radio uses radio waves to carry information, such as, but not limited to, sound, by systematically modulating properties of electromagnetic energy waves transmitted through space, such as their amplitude, frequency, phase, or pulse width. When radio waves strike an electrical conductor, the oscillating fields induce an alternating current in the conductor. The information in the waves can be extracted and transformed back into its original form.

Radio systems need a transmitter to modulate (change) some property of the energy produced to impress a signal on it, for example using amplitude modulation or angle modulation (which can be frequency modulation or phase modulation). Radio systems also need an antenna to convert electric currents into radio waves, and radio waves into an electric current. An antenna can be used for both transmitting and receiving.

The electrical resonance of tuned circuits in a radio allow individual frequencies to be selected. The electromagnetic wave is intercepted by a tuned receiving antenna. A radio receiver receives its input from antenna 351, and converts it into a form that is usable for the consumer, such as sound, pictures, digital data, measurement values, navigational positions, etc. Radio frequencies occupy the range from a 3 kHz to 300 GHz, although commercially important uses of radio use only a small part of this spectrum.

A radio communication system, such as, but not limited to a Cell Networks 120, 121 as illustrated in FIG. 1 and FIG. 2, requires a transmitter and a receiver, each having an antenna and appropriate terminal equipment such as a microphone at the transmitter and a loudspeaker at the receiver in the case of a voice-communication system.

To distinguish signals from several different transmitters, time-division multiple access (TDMA), frequency-division multiple access (FDMA), code-division multiple access (CDMA), and orthogonal frequency-division multiple access (OFDMA) were developed.

With TDMA, the transmitting and receiving time slots used by different users in each cell are different from each other.

With FDMA, the transmitting and receiving frequencies used by different users in each cell are different from each other. In a simple taxi system, the taxi driver manually tuned to a frequency of a chosen cell to obtain a strong signal and to avoid interference from signals from other cells.

The principle of CDMA is more complex, but achieves the same result; the distributed transceivers can select one cell and listen to it.

Other available methods of multiplexing such as polarization-division multiple access (PDMA) cannot be used to separate signals from one cell to the next since the effects of both vary with position and this would make signal separation practically impossible. TDMA is used in combination with either FDMA or CDMA in a number of systems to give multiple channels within the coverage area of a single cell.

A booster is an amplifier, electronic amplifier, or amp, is an electronic device that can increase the power of a signal (a time-varying voltage or current). An amplifier uses electric power from a power supply to increase the amplitude of a signal. The amount of amplification provided by an amplifier is measured by its gain: the ratio of output voltage, current, or power to input. An amplifier is a circuit that has a power gain greater than one.

Safer Gateway 150, includes Antennae 301, 321, 351. An antenna is the interface between radio waves propagating through space and electric currents moving in metal conductors, used with a transmitter or receiver. During transmission, a radio transmitter supplies an electric current to the antenna's terminals, and the antenna radiates the energy from the current as electromagnetic waves (radio waves).

During reception, an antenna intercepts some of the power of an electromagnetic wave in order to produce an electric current at its terminals, which is applied to a receiver to be amplified. Antennas are essential components of all radio equipment, and are used in radio broadcasting, broadcast television, two-way radio, communications receivers, radar, cell phones, satellite communications and other devices.

An antenna is an array of conductors (elements), electrically connected to the receiver or transmitter. During transmission, the oscillating current applied to the antenna by a transmitter creates an oscillating electric field and magnetic field around the antenna elements.

These time-varying fields radiate energy away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna.

Antennas can be designed to transmit and receive radio waves in all horizontal directions equally (omnidirectional antennas), or preferentially in a particular direction (directional or high gain antennas). An antenna may include parasitic elements, parabolic reflectors or horns, which serve to direct the radio waves into a beam or other desired radiation pattern.

### PRACTICAL USES OF THE PRESENT INVENTION

The present invention relates to a system, method, and apparatus for mitigating electromagnetic radiation (EMR) that is potentially harmful to human beings, particularly, man-made sources of EMR. The goal of the present invention is to create EMR safer Spaces.

The problem with cell phones, WiFi, Bluetooth, Z-Wave and ZigBee radios isn't single radios operating within a space, it is the cumulative effect of dozens, or hundreds, or even thousands of radios (EMR sources) operating within a space.

The almost exclusive use of integrated wireless radios, such as, but not limited to WiFi, Bluetooth, Z-Wave, ZigBee, etc., by Internet of Things (IoT) devices will make the problem of EMR on humans even worse.

The Internet of Things refers to the merging of the physical and digital worlds. Today, it is estimated over eight billion devices around the world are connected to the Internet, collecting and sharing data. It is estimated by 2020, the number of IoT devices will rise to over twenty billion. This is possible due to cheap processors and wireless networks. Today, anything from a pill to an airplane, can become a part of the IoT.

Cisco routinely quantifies the IoT as a nineteen trillion dollar opportunity, and accordingly, the problem of EMR is being rapidly multiplied due to market forces.

As an example, sitting at a 100 square meter coffee shop, or another place where the public has access to WiFi 130, 131 as illustrated in FIG. 1, becomes more problematic with regard to EMR because a human being is being exposed to not only their own sources of EMR from personal devices such as, but not limited to, WiFi Router 130, 131, Cell Phones 140, 141, tablet computers (not shown), laptop computers (not shown), etc., but also to the EMR emanating from perhaps dozens of other personal devices (not shown) within the near vicinity.

The present invention's system as illustrated in FIG. 2 and FIG. 3 is designed to mitigate EMR in designated safer spaces through a variety of methods and apparatuses. One, or more, of the following methods may be employed together to mitigate EMR.

One method to decrease EMR is to decrease the distance between a wireless broadcast antenna integrated in a device such as, but not limited to, Cell Phone 140, 141, 142, or tablet computer (not shown) and Cell Networks 120, 121 and/or Safer Gateway 150, 151. This seems counter-intuitive at first, but the implication of this strategy is that by decreasing the distance between a pair of transmit and receive antennae means more wireless access points are needed, but the broadcast power of each of the pair of antennae can be reduced significantly. This is an effective strategy since wireless path loss is the reduction in power density that occurs as a radio wave propagates over a distance. The primary factor in path loss is the decrease in signal strength over distance of the radio waves themselves. Radio waves follow an inverse square law for power density, which means the power density is proportional to the inverse square of the distance. Every time the distance is doubled from a transmitter to a receiver, approximately one-fourth the power is received.

As a practical example, in FIG. 1, if a single WiFi Router 130 is required to cover the footprint of the coffee shop referenced previously, and the furthest distance between the WiFi Router 130 and Cell Phone 140, is approximately seven meters, and if the required power at Cell hone 140 is 0.08 watts, the WiFi Router 130 would have to broadcast it's signal at approximately 4.0 watts in order to effectively reach Cell Phone 140.

However, if in FIG. 2, the distance between Safer Gateway 150 and Cell Phone 140 is half the distance of the example cited in the previous paragraph for FIG. 1, or 3.5 meters, then four Safer Gateway 150 devices would be required to cover the same footprint of the example cited in the previous paragraph for FIG. 1. If the Cell Phone 140 requires 0.08 watts of received power to function properly, then Safer Gateway 150 would have to broadcast it's signal at approximately 1.0 watt in order to effectively reach Cell Phone 140. This is a reduction of 4× for the broadcast signal power required, for persons located directly beneath Safer Gateway 150. But, the real benefit is the total average power radiated per square meter, for the present invention in the coffee shop example, is approximately 40% vs. the current art. It should be noted, in this example, the WiFi Router 130 as illustrated in FIG. 1, and the Safer Gateway 150 as illustrated in FIG. 2, are located approximately in the center of a square footprint.

Another method is to increase the distance between the cellular antenna and a human being. In FIG. 1, the current art is illustrated, in which a device such as, but not limited to, Cell Phone 140, 141, tablet computer (not shown), laptop computer (not shown), desktop computer (not shown), smart TV (not shown), wireless printer (not shown), etc., can transmit data either to the Cell Network 120, 121 via a cellular protocol on Com Path 162, 163, or to a WiFi Router 130, 131 via WiFi protocol on Com Path 180, 181 in order to reach Servers 110, 111, 112 operating on Cloud 100. In FIG. 2, the present invention is illustrated, in which Cell Phone 140, 141, 142, tablet computer (not shown), laptop computer (not shown), desktop computer (not shown), smart TV (not shown), wireless printer (not shown), etc., can only transmit data in a safer space to Safer Gateway 150, 151 via WiFi protocol on Com Path 180, 181,182. It should be noted, that in the present invention, the preferred method for making a voice call is via WiFi calling. Using WiFi calling allows the Smart Gateway 150, 151 to make the intelligent decision as to whether a voice call is routed immediately to Cell Network 120, 121 via Com Path 162, 163, or via WiFi and to the Cloud 100 via Com Path 170, 171. The primary advantage of the Safer Gateway in the example, is a device such as, but not limited to, Cell Phone 140, 141, 142, tablet computer (not shown), or other device that include an integrated cellular modem, or are connected to a stand-alone cellular modem, don't have to use their cellular network radios (not shown) in order to transmit data.

Cellular network radios typically operate at a much higher broadcast power, because the device is trying to reach a distant tower on a ell Network 120, 121. Using WiFi as the primary wireless technology in a safer space means radios can operate at a much lower broadcast power. Cellular radios can operate at 10× to 20× higher broadcast powers than WiFi radios. This is the primary advantage of the present invention, whether the Safer Gateway 150 illustrated in FIG. 3, are using either antennae 351 to reach the Cell Network 120, 121, or Ethernet NIC 310 to connect to an Internet modem on an Internet Service Provider's (ISP) network. As an example, in the coffee shop example cited previously, if there are twenty users simultaneously talking on Cell Phones 140, 141, 142 via cellular protocols, they may be using up to forty watts of collective power vs. approximately five watts collectively using WiFi protocols and WiFi calling protocols. This is a significant reduction of approximately 8× in total EMR within the coffee shop operating a safer Space.

Combining the use of the Safer Gateway 150 (shown in FIG. 3) with an increased number of Safer Gateways 150, 151 operating at a lower broadcast power that is possible to the inverse square law for power density, which means the power density is proportional to the inverse square of the distance, the total EMR in a safer Space could be reduced by another 40%, which means the total broadcast power for twenty simultaneous users in the space illustrated in FIG. 2 vs the present art illustrated in FIG. 1, would amount to an approximate reduction of total EMR by a factor of 20×. This is significant.

Another strategy is to use an app that is downloaded onto a personal device, such as, but not limited to, a Cell Phone 140, 141, 142, tablet computer (not shown), or other device that include an integrated cellular modem, or are connected to a stand-alone cellular modem, which automatically switches off an enabled device's cellular radio within a safer space, and automatically switches to WiFi communications only. This strategy can be thought of as a type of “automated super airplane mode that includes automatic log-in”. This hands-off approach means a user doesn't have to remember to turn their personal device's cellular off, and turn their WiFi back on, turn on WiFi calling, and then log onto the Internet connection for the room, or building, where the safer space is located. This saves precious time in transitioning a personal device, such as, but not limited to, a cell phone, smartphone, tablet computer, etc., to the reduced EMR safer space mode.

Another way the present invention mitigates EMR radiation is through the use of wired Ethernet connections to the Safer Gateway 150, 151, so all wireless radios on a device such as, but not limited to, a Cell Phone 140, 141, 142, tablet computer (not shown), laptop computer (not shown), desktop computer (not shown), smart TV (not shown), wireless printer (not shown), etc., can be turned off. A personal device with a micro or mini-USB port (not shown), such as, but not limited to, Cell Phone 140 141, 142, or tablet computer (not shown), can use a “micro- or mini-USB to Ethernet cable” (not shown) to connect the personal device to a “wall plate with an RJ45 Jack” (not shown), which is connected via CAT 5/6/7 cabling to the Safer Gateway 150, 151, via Ethernet NIC 310s RJ45 Jacks 311, 312, as illustrated in FIG. 3. This method totally eliminates a personal device such as, but not limited to, Cell Phone 140, 141, 142, tablet computer (not shown), laptop computer (not shown), desktop computer (not shown), smart TV (not shown), wireless printer (not shown), etc., use of wireless radios, which emit EMR nearby, and into a space, such as, but not limited to a room, the floor of a building, an entire building, etc. This method would eliminate virtually all of the EMR in a safer space.

The present invention anticipates the use of anti-radiation fabrics, and anti-radiation paints (coatings) on walls and ceilings that absorb extraneous multi-path signals. This reduces the overall EMR radiation in a safer space.

The present invention also anticipates the creation of mini-safer space rooms within a larger room that are designed to shield a human being from much of the uncontrolled EMR while in the mini-safer space room.

The present invention may also shift wireless transmit and receive signals to radio frequency carrier waves that are less harmful to human beings.

The present invention may optionally shift wireless transmit and receive signals to radio frequency carrier waves that are beneficial to human beings.

The present invention includes an enterprise back-end information technology system that operates in the public Cloud, a private Cloud, a hybrid public Cloud, or a hybrid public-private Cloud.

The present invention also includes apps that can be downloaded to devices such as, but not limited to, Cell Phone 140, 141, 142, tablet computer (not shown), etc., that interact with the present invention's Safer Gateway 150, 151 which is an “integrated wireless access point—controller area network engine—cellular network antenna booster device”, which helps to mitigate EMR within a safer space.

The present invention also includes software that can be downloaded to devices such as, but not limited to, laptop computers (not shown), and desktop PCs (not shown) that interact with the present invention's Safer Gateway 150, 151 which is an “integrated wireless access point—controller area network engine—cellular network antenna booster device”, which helps to mitigate EMR within a safer space.

The present invention can also be included on firmware operating on a device that uses WiFi such as, but not limited to, a Smart TV wireless networked printer streaming device that plugs into an HDMI port, a voice activated assistant (not shown), an Internet of Things device that uses ZigBee (not shown), an Internet of Things device that uses Bluetooth (not shown), etc.

The following is a description in layman's terms of how the present invention works to reduce a human's exposure to electromagnetic radiation in a “Safer Space”.

The person, Mary, in this story is equipped with an app that interacts with the “Safer Space”.

The action takes place in a coffee shop that uses “Safer Space” technology.

As Mary enters the coffee shop, her “Safer Space” cellphone app that she has downloaded, detects that the coffee shop she is about to enter has “Safer Space” technology.

The app uses technology such as, but not limited to, Bluetooth Beacons that broadcast a message to a cellphone, such as, “Coffee Shop 101, 2200 sf, “Safer Space” Operating=Yes, Safer Room Available=No, Absorption Materials In Use=Yes, Number of “Safer Space” Gateways=5, In-wall Ethernet Jacks=Yes, Mirco-USB to Ethernet Cables Available For Customer Use=No.

Mary's cellphone receives the Bluetooth Beacon message, and when she opens her “Safer Space” app, the GUI provides a “Safer Space” score for the coffee shop, which is based on the parameters received in the Bluetooth Message, and also other parameters, such as, but not limited to, the number of electronic devices using “Safer Space” technology, the number of customer's electronic devices that are not using “Safer Space” technology, other sources of radiation, such as, microwave ovens, TVs, set-top boxes, computer, tablet, monitor, game box, video recorder, etc.

In addition to Bluetooth, Mary's “Safer Space” app can use location based technology to search an index of geo-graphically tagged “Safer Spaces”.

Perhaps, Mary's app provides a “Safer Space” score of 95, and a green bar that indicates this coffee shop has reduced his electromagnetic radiation footprint as much as possible.

The app keeps track of the “Safer Spaces” that Mary enters, how long she lingers, how often she visits them, and can be programmed to provide a bigger picture to her about her long-term electromagnetic radiation exposure.

The app may provide a search list of coffee shops within a certain radius, which can be a link to menus, opening and closing times, and their “Safer Space” scores.

Once Mary enters the coffee shop, the app on her cellphone automatically shuts down her cellphone radio, and turns on Wi-Fi calling.

So, Wi-Fi, which uses less power, is now the only way in which she can connect to the Internet or make a phone call.

Because, this coffee shop uses five “Safer Space” Gateways that are operating at a lower broadcast power, Mary's exposure to radiation is reduced.

Mary prefers to connect to the Internet using an Ethernet Jack next to the table she has chosen to sit at.

When she plugs in, her cellphone battery is automatically charged as she also surfs the Internet for pleasure, or for work.

The app on her cellphone is constantly interacting with the hardware in the “Safer Space”, and if the electromagnetic radiation increases due to an influx of customer's that don't use “Safer Space” technology, and the overall score for the coffee shop drops to 50, Mary's phone alerts her to the change. This way, she can make an informed decision to leave the “Safer Space”, or to wait it out for a few minutes.

Because people who are conscientious of shopping, living, and working in “Safer Spaces” they provide a distinct demographic.

This distinct demographic can be used by advertisers to promote their own “Safer Space” places of business, or products that would appeal to the “Safer Space” demographic.

The social media engine can be used to connect “Safer Space” users with other like-minded “Safer Space” users. This interaction can be done thru any number of existing social media engines, such as, but not limited to, Facebook, Twitter, Google Hangouts, Instragram, or text messaging, emails, and voice, or the “Safer Space” app itself.

The “Safer Space” app has an on-line store where “Safer Space” users can purchase a Micro-USB to Ethernet cable so they can plug in, instead of use wireless, or they can research the electromagnetic radiation score provided by “Safer Space” consumer research department for SmartTVs, wireless printers, microwave ovens, etc., as they choose to make purchases through the app, or via Amazon, or other on-line shop, or in a Brick-n-Mortar store.

Mary's “Safer Space” app can be programmed with Mary's preferences, such as, I only want to shop in “Safer Space” establishments with an average minimum “Safer Space” EMR Score of 70, Keep Cellphone Radio Off Unless I Use The App To Turn It On, or I Want To Receive “Safer Space” Marketing Messages, etc.

Mary can use her “Safer Space” app to give a Thumbs Up, or Thumbs Down, on a “Safer Space” business as well.

The present invention has been described in particular detail with respect to several possible embodiments. Those of skill in the art may appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various systems components described herein is merely exemplary, and not mandatory. Functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms.

Furthermore, the computers referred to in the specification may include a single processor or may be architectures employing multiple processor designs for increased computing capability. The scope of this invention should be determined by the appended claims and their legal equivalents, rather than by the examples given. Lastly, various technologies that support present invention are described in the attachments to this provisional patent filing.

What is claimed is:

1. A method for reducing electromagnetic exposure to an end user of an electronic device, the method comprising:
providing a safer space to reduce harmful electromagnetic radiation, the safer space created as a result of:
emitting radio waves through a first wireless access point and a second wireless access point located within the safer space;
establishing communication with an end user electronic device; and
intelligently reducing emissions of radio waves from the first wireless access point or the second wireless access point based on the location of the end user electronic device within the safer space.

2. The method for reducing electromagnetic exposure to an end user of an electronic device, of claim 1 wherein the method further comprises absorbing harmful electromagnetic radiation within the safer space.

3. The method for reducing electromagnetic exposure to an end user of an electronic device, of claim 1 wherein the method further comprises altering a frequency transmitted by the end user electronic device.

4. The method for reducing electromagnetic exposure to an end user of an electronic device, of claim 1 wherein the method further comprises turning off a cellular transmission signal from the end user electronic device without end user input.

5. The method for reducing electromagnetic exposure to an end user of an electronic device, of claim 1 wherein the method further comprises intelligently switching the end user electronic device to transmit signals through a wi-fi connection instead of a cellular connection without user input.

6. The method for reducing electromagnetic exposure to an end user of an electronic device, of claim 1 wherein a density of wireless access points within the safer space is greater than a density of wireless access points outside of the safer space.

7. The method for reducing electromagnetic exposure to an end user of an electronic device, of claim 1 wherein the method is performed on an app running on the end user electronic device connected to a server operatively controlling the wireless access point.

8. A system for mitigating man-made electromagnetic radiation comprising:
a wireless broadcasting antenna for emitting radio waves;
a personal device having antennae, said antennae including a wireless receiving antenna for receiving the radio waves;
a safer space substantially free from harmful electromagnetic radiation, the safer space created as a result of:
intelligently turning off broadcast power or wireless communications of the personal device;
intelligently turning off a wireless access point; and/or shifting a frequency of a wireless transmission.

9. The system of claim 8 wherein the antennae of the personal device operate on a low-power wireless standard.

10. The system of claim 8 further comprising a cloud-based, enterprise back-end information technology system to deploy safer space functionality.

11. The system of claim 10 wherein the safer space functionality comprises:
operation of a web application and/or service;
client identification;
password verification; and/or granting rights and/or permissions.

12. The system of claim 8 wherein the personal device further comprises a controller area network engine and a cellular network antenna booster.

13. The system of claim 12 wherein the personal device includes a non-transitory computer readable medium capable of executing a software application to coordinate communication between the wireless access points, the controller area network engine, and the cellular network antenna booster.

14. The system of claim 8 wherein the personal device uses Z-Wave, Zigbee, Bluetooth, or Wi-fi.

15. The system of claim 8 further comprising integrated wired routers for connecting to the wireless access points.

16. The system of claim 8 further comprising an electromagnetic radiation absorbing material within the safer space.

17. The system of claim 8 further comprising an electromagnetic radiation mitigating enclosure for the personal device.

18. The system of claim 8 further comprising a power source for powering the personal device.

19. A system for mitigating man-made electromagnetic radiation comprising:
a wireless broadcasting antenna for emitting radio waves;
a personal device having antennae, said antennae including a wireless receiving antenna for receiving the radio waves;
a safer space substantially to minimize harmful electromagnetic radiation, the safer space created as a result of:
absorbing harmful electromagnetic radiation;
reducing antennae broadcast power;
selecting a wireless access point within the safer space to minimize the distance between antennae of the personal device and a wireless access point;
intelligently turning off broadcast power or wireless communications of the personal device;
intelligently turning off a non-selected wireless access point; and/or shifting a frequency of wireless transmissions.

20. The system of claim 19 wherein the personal device includes a non-transitory computer readable medium capable of executing a software application to coordinate communication between the selected wireless access point, a controller area network engine, and the wireless broadcasting antenna.
